(19) United States
(12) Patent Application Publication
(10) Pub. No.: US 2024/0111031 A1
(43) Pub. Date: Apr. 4, 2024

(54) LASER INSPECTION AND MEASUREMENT SYSTEMS AND METHODS

(71) Applicant: 3D at Depth, Inc., Longmont, CO (US)

(72) Inventors: Carl W. Embry, Boulder, CO (US); Jeremy D. Swedberg, Lafayette, CO (US); Dominic M. Florin, Longmont, CO (US); Nelson Diaz, Westminster, CO (US); Neil Manning, Katy, TX (US)

(73) Assignee: 3D at Depth, Inc., Longmont, CO (US)

(21) Appl. No.: 18/374,768

(22) Filed: Sep. 29, 2023

Related U.S. Application Data
(60) Provisional application No. 63/412,794, filed on Oct. 3, 2022.

(51) Int. Cl. G01S 7/481; G01S 7/499; G01S 17/89; G02B 26/08; G02B 26/10

(52) U.S. Cl. CPC G01S 7/4817; G01S 7/499; G01S 17/89; G02B 26/0816; G02B 26/10

(57) ABSTRACT

Methods and systems for improved inspection, measurements, mapping, monitoring, and trending of underwater infrastructure that contains or are located in fluids, and/or that is difficult to access. The methods and systems include a housing containing a light source, a hollow core motor, a reflector, and a pressure tolerant window. The light source is disposed to pass output light along a path that passes through an axis of rotation of the hollow core motor to the reflector. The reflector rotates about the axis of rotation of the motor and operates to reflect the light at an angle to the rotation axis. In at least some embodiments, the light is passed through a full 360 degrees about the axis of rotation. The described methods and devices utilize one or more non-touch underwater optical system (including laser systems) for underwater equipment and infrastructure inspection, measurements, mapping, monitoring, trending, and maintenance.

### CROSS-REFERENCE TO RELATED APPLICATIONS

This application claims the benefit of U.S. Provisional Patent Application Ser. No. 63/412,794, filed Oct. 3, 2022, the entire disclosure of which is hereby incorporated herein by reference.

### FIELD

The present disclosure is directed to methods and systems for remote, contactless, wide angle (up to 360°) measurements and inspections in piping and other environments.

### BACKGROUND

Various applications or situations call for or can benefit from precise inspections of systems and infrastructure. However, equipment or components to be inspected can often be in locations or environments that make access difficult. In addition, once access is achieved, the conditions around or within the equipment or components thereof can make the inspection difficult to perform. For example, it is often desirable to map or otherwise determine the actual state or location of various types of underwater installations or equipment. In addition, a common challenge in connection with such installations or equipment is obtaining accurate location or condition data while the installations or equipment remain in an operational or nearly operational state. Such underwater installations can include, but are not limited to, well heads, pipelines, pumps, dams, hydroelectric facilities, nuclear reactor facilities, and the like. Other installations or equipment for which surveys or assessments may be desired include pipelines, storage tanks, or other vessels that themselves contain a fluid.

Various inspection techniques and systems have been developed for inspecting underwater or subsea equipment. For instance, visible light cameras carried by submersible vehicles can be used to obtain images of the equipment. Cameras configured for insertion in pipelines are also available. However, passive inspection systems that use conventional cameras have limited utility when the water or other fluid surrounding or contained within equipment being inspected is not clear to visible light. In addition, it is difficult to make accurate measurements from two-dimensional cameras. Other inspection systems use sound waves to obtain three-dimensional images of equipment. However, such sonar systems can suffer from poor resolution and accuracy along with multi-path errors when in enclosed metallic spaces.

In addition, underwater camera inspections produce video data that is required to be stored. This video data will vary from a few minutes in length to tens of hours of video footage. Underwater camera inspection data must be reviewed and retained for several years in many scenarios. Sorting through hours and hours of conventional underwater camera video can be labor intensive and creates error-likely situations. Reviewers of the data months or years later for reference or trending could easily pass over the key information in video and in many cases just fail to find the correct footage needed.

Accordingly, it would be desirable to provide systems and methods that allowed for the non-contact, remote, wide angle measurement and inspection of equipment within difficult environments including pipelines. An accurate, wide angle underwater measurement method is desired.

### SUMMARY

The present disclosure provides systems and methods for the measurement and inspection of any and all structures or equipment through a wide viewing area. In particular, systems and methods in accordance with embodiments of the present disclosure provide for 360° viewing for inside pipes, tunnels and waterways, especially ones that are filled with water or other liquids. This includes, but is not limited to, pipelines, tunnels, penstock, waterways, and downhole applications. Embodiments of the present disclosure can also be applied to open area wide-angle viewing (for instance a 150° field of view) for underwater mapping of larger areas. This can include the seafloor, lakebeds, structures on the seafloor, hydroelectric dams, and nuclear reactor pools. The described systems and methods utilize one or more non-touch underwater optical systems (including laser systems) for the inspection, measurement, diagnosis, mapping, monitoring, and trending of underwater assets and environments. Monitoring of underwater systems can include inspection, measurements, mapping, monitoring and trending along with detection of shifts in location over time, vibrations, flow rates, temperature, degradation and/or leaks of underwater assets and environments. The improved information can inform engineering decisions and design improvements for underwater assets.

Systems in accordance with embodiments of the present disclosure can include various optical sensors provided as part of active, light-based metrology systems or sensors. In accordance with at least some embodiments of the present disclosure, a monitoring system is provided in the form of a light detection and ranging system (hereinafter “lidar”) monitoring device. In such embodiments, the lidar device can be provided as a scanning lidar, flash lidar, flash Time of Flight (ToF) lidar, pulsed laser lidar, amplitude modulated continuous wave (AMCW) phase detection lidar, chirped AMCW lidar, amplitude frequency modulated continuous wave (FMCW) lidar, true FMCW lidar, pulse modulation code, or other lidar system. Moreover, the lidar system can incorporate a pulsed or modulated continuous wave laser light source. Other embodiments can include a monitoring system incorporating a laser triangulation, photometric stereo, stereoscopic vision, structured light, photoclinometry, stereo-photoclinometry, holographic, digital holographic, or other device that uses light to sense three-dimensional (3-D) space.

In accordance with embodiments of the present disclosure, a lidar system is provided. The components of the lidar system can be entirely or partially disposed within a watertight, submersible enclosure or housing. The components can include, but are not limited to, a light source, a scanning assembly, and a receiver. A window provided at an end or a side surface of the housing enables light from the light source to be scanned across a field of view in an environment surrounding the lidar system, and further allows reflections from objects or materials within the environment to be passed to the receiver. The window and scanning assembly can be configured to enable a full, 360° angle of view, or some lesser angle of view (e.g. 150°, 120°, or 90°). In addition, the lidar system can be configured for mounting to a vehicle, for being hand carried, or for being inserted into a pipeline or other fluid containing structure.

In operation, the lidar system is placed in the vicinity of the equipment to be monitored. In accordance with embodiments of the present disclosure, multiple pieces of equipment can be monitored by a single lidar system. In accordance with further embodiments of the present disclosure, at least portions of the system are placed within pipelines or conduits of the equipment to be monitored. For example, embodiments of the present disclosure can be adapted for performing surveys of water supply systems, hydrocarbon pipelines, intake and cooling water systems, waste water systems, or other structures that contain or are adapted to contain fluids.

Additional features and advantages of embodiments of the present disclosure will become more readily apparent from the following description, particularly when taken together with the accompanying drawings.

### BRIEF DESCRIPTION OF THE DRAWINGS

FIG. 1 depicts lidar systems in accordance with embodiments of the present disclosure operating in an example underwater environment;

FIGS. 2A and 2B depict a lidar system in accordance with embodiments of the present disclosure operating in an example fluid filled pipeline;

FIG. 3 depicts a submersible housing or pressure vessel in accordance with embodiments of the present disclosure with a window for 360° scanning;

FIG. 4 depicts a close-up, perspective view of a window and scanning mechanism in accordance with embodiments of the present disclosure;

FIG. 5 depicts a close-up, side elevation view of a window and scanning mechanism in accordance with embodiments of the present disclosure;

FIG. 6 depicts an exploded view of a window, output cap, scanner, and scanning optics in accordance with embodiments of the present disclosure;

FIGS. 7A and 7B illustrate outer rings having deflection reducing features in accordance with embodiments of the present disclosure;

FIG. 8 depicts an underwater housing or pressure vessel in accordance with other embodiments of the present disclosure with a window and a shroud to protect the window and limit the field of view to less than 360°;

FIG. 9 depicts a close-up of another embodiment of the window, scanning prism mechanism, and protective shroud;

FIG. 10 depicts a close-up of a protective shroud in accordance with other embodiments of the present disclosure;

FIG. 11 depicts a close-up of a protective shroud in accordance with other embodiments of the present disclosure;

FIG. 12 is an example of a complete pressure tolerant scanning optical system or lidar assembly in accordance with other embodiments of the present disclosure;

FIG. 13 is an example of a complete pressure tolerant 360° scanning optical system in accordance with other embodiments of the present disclosure, without a protective shroud;

FIG. 14 is a close-up, perspective view of a window in accordance with other embodiments of the present disclosure;

FIGS. 15A-15C depict reflector arrangements in accordance with embodiments of the present disclosure;

FIGS. 16A-16D depict optical window configurations in accordance with other embodiments of the present disclosure;

FIG. 17 depicts a submersible housing in accordance with embodiments of the present disclosure;

FIG. 18 is a conceptual depiction of a transverse cross section of a submersible housing in accordance with embodiments of the present disclosure;

FIGS. 19A-19D depict components of light detection and ranging systems in accordance with embodiments of the present disclosure;

FIG. 20 depicts components of a monitoring and control station included in a system in accordance with embodiments of the present disclosure; and

FIG. 21 depicts aspects of a user interface in accordance with embodiments of the present disclosure.

### DETAILED DESCRIPTION

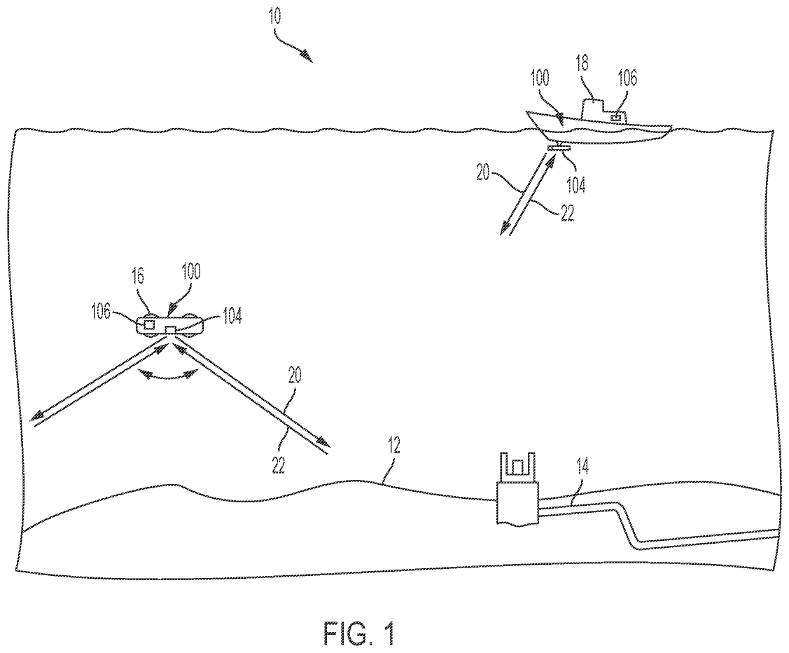

FIG. 1 depicts an example of an underwater environment 10, here including a seabed and other natural features 12, and manmade components and installations 14, such as a pipeline, in which an optical measurement and inspection system in accordance with embodiments of the present disclosure, also referred to herein as a light detection and ranging (LIDAR or lidar) system 100, can be operated. In general, the lidar system 100 includes a submersible housing 104 that contains some or all of the components of the lidar system 100. The submersible housing 104 can be operatively connected to a control system 106. The control system or box 106 can be carried by the same platform as is carrying the submersible housing 104. Alternatively, the control system 106 can be carried by a platform that is different from the platform carrying the submersible housing 104. In the example of FIG. 1, a first instance of the lidar system 100 is carried by a submersible vehicle 16. Also in this example, a second instance of the lidar system 100 is carried by a surface vessel 18. In each case, the lidar system 100 can be mounted to an exterior of the submersible vehicle 16 or to an exterior of the surface vessel 18. Alternatively, the lidar system 100 can be mounted to an interior of the submersible vehicle 16 or an interior of the surface vessel 18, in which case a window in the vehicle is provided to enable light to be transmitted to and received from the surrounding environment. As depicted with respect to the submersible vehicle 16, transmitted light (i.e. an output beam) 20 can be directed across a wide field of view and received light (i.e. a return signal) 22 can be received from within that same wide field of view (in this example about 120°). As can be appreciated by one of skill in the art after consideration of the present disclosure, and as depicted with respect to the surface vessel 18, as the lidar system 100 moves with an associated platform, areas of the surrounding environment can be scanned in sequence.

As can appreciated by one of skill in the art after consideration of the present disclosure, the lidar system 100 can be operated to obtain range and angle information between the submersible housing 104 and points in the surrounding environment 10, including but not limited to points on objects, features, and certain phenomena in the environment 10, by transmitting light, and by receiving reflections of that light. The resulting data can be used for various purposes, such as the creation three-dimensional maps or surveys or natural and manmade underwater features, validating the proper emplacement of equipment, real time navigation through the underwater environment, or the like.

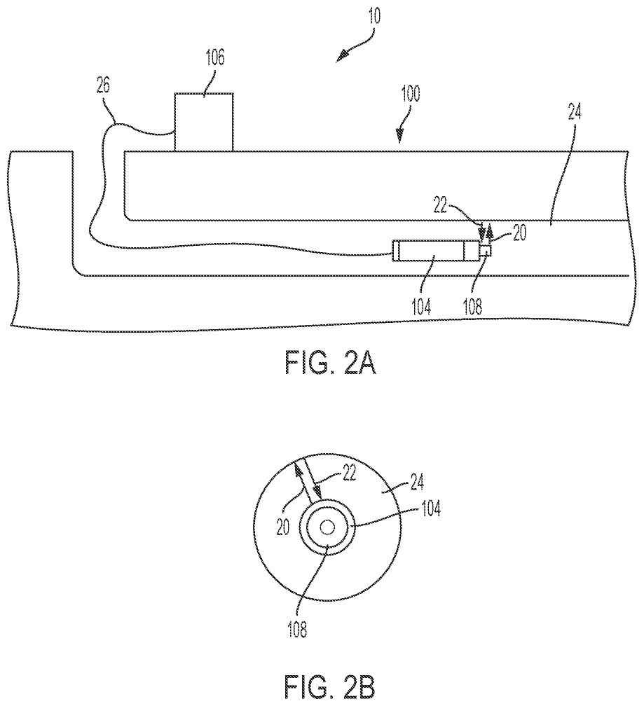

FIGS. 2A and 2B depict a lidar system 100 in accordance with embodiments of the present disclosure operating within an environment 10 in the form of a fluid filled pipeline 24. More particularly, FIG. 2A depicts the pipeline 24 in a longitudinal cross-section, while FIG. 2B depicts the pipeline in a transverse cross-section. As shown, the lidar system 100 in this example provides a full, 360° scan of the interior surface of the pipeline 24. In addition, in this example the lidar system 100 is configured as a submersible housing 104 that is joined to a control system or box 106 by an intermediate member in the form of a tether or umbilical cord 26 that can be used to pass control information, data, and/or power between the submersible enclosure 104 and the control system 106.

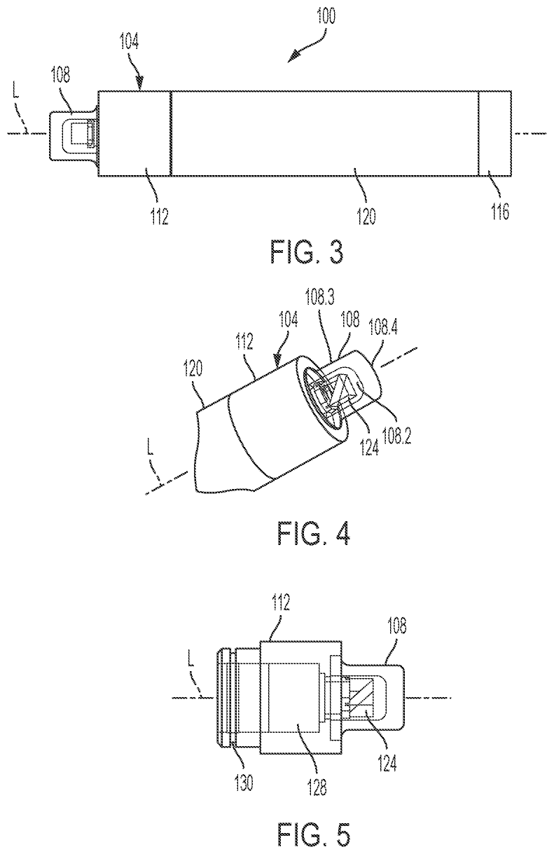

FIG. 3 depicts the submersible housing 104 of an optical measurement and inspection system or lidar system 100 in accordance with embodiments of the present disclosure. As an example, but without limitation, the submersible housing 104 can be configured as an optical head containing a subset of the components of the lidar system 100. Alternatively, all of the components of the lidar system 100 can be contained within the submersible housing 104. The submersible housing 104 of the lidar system 100 is generally configured as an underwater housing or pressure vessel with a pressure tolerant window 108 for scanning across a range of angles. The housing 104 can be designed and configured for use in various underwater applications. In at least some embodiments of the present disclosure, the submersible housing 104 is designed for extreme pressures and temperatures. In accordance with still further embodiments, the submersible housing 104 is sized and configured for placement in a pipeline or other structure that contains or is adapted to contain or carry a fluid. Moreover, the submersible housing 104 can be included in or associated with a tether, umbilical cord, power module, crawler, rover, drone, or the like. The submersible housing 104 generally includes first 112 and second 116 endcaps, and a center section or tube 120, between the two endcaps 112 and 116. Alternately the center section 120 can include an enclosed end so there is only one endcap. The endcaps 112 and 116 generally use an o-ring seal for underwater use. In the embodiment depicted in FIG. 3, the window 108 is disposed in or associated with the first endcap 112. In accordance with at least some embodiments, the housing 104 and endcaps 112 and 116 are formed of metal. In accordance with other embodiments, the housing 104 and endcaps 112 and 116 are formed from a composite. In accordance with still other embodiments, some or all of the submersible housing 104 components are formed from different materials. For instance, the endcaps 112 and/or 116 can be formed from metal, plastic, carbon fiber, sapphire, glass, composite or ceramic, while the center section 120 can be metal. The window 108 is formed from a material that transmits light of selected wavelengths. Examples of suitable materials include, but are not limited to, glass, crystal, plastic, or composite. Where the first endcap 112 is formed from a transparent material, a separate window 108 can be omitted.

FIG. 4 depicts a close-up, perspective view of the pressure tolerant window 108 and of portions of a scanning mechanism 124 of the embodiment of the lidar system 100 of FIG. 3 in a perspective view. In general, the scanning mechanism 124 is positioned within an interior volume of the housing 104, extending to within an interior volume 108.2 of the window 108, and adjacent an optical viewing port corresponding to a lateral transmissive portion 108.3 located along the sides of the window 108. The optical viewing port of the window 108 of the embodiment of FIG. 4 allows for 360° scanning about an axis of the scanning mechanism 124, which can be coincident with a longitudinal axis L of the submersible housing 104. Alternatively, the axis of the scanning mechanism 124 can be parallel to but offset from the longitudinal axis L of the submersible housing 104, or the axis of the scanning mechanism 124 can be at some non-zero angle relative to the longitudinal axis L of the submersible housing 104. The end 108.4 of the window 108 can be configured as a longitudinal transmissive portion and can be used for forward scanning. The pressure tolerant window 108 is sealed to the output or first endcap 112 to prevent water intrusion, especially at high pressures and temperatures. Methods of sealing include o-ring seals between the window 108 and the endcap 112. Another method is to bond the window 108 to the endcap 112 using an epoxy or other bonding agent. Still another method is to metalize the interfacing surfaces of the window 108 and then solder or braze the window 108 to the endcap 112. Other techniques can include welding and glass frit sealing.

In an additional embodiment, a lens is imprinted on one or transmissive portions of the output window 108 (for example a Fresnel lens, diffractive optic, or computer generated hologram) to increase the reflected light returned to the optical path and still allow for an undistorted output beam path. As an example, an imprinted lens that is provided integrally with the end or longitudinal transmissive portion 108.3 of the window 108 can be radially symmetric about the longitudinal axis and can focus light along the output cap 112 length, thus producing a single-axis lens, onto a center collection area of the scanning mechanism 124. As another example, circumferential trenches and ridges could be formed on an outer, inner, or both outer and inner surfaces of the lateral transmissive portion 108.3 of the window. For instance, a series of ridges extending from a center ridge can be configured as blazed gratings. As can be appreciated by one of skill in the art after consideration of the present disclosure, the features can be configured to concentrate light gathered from a wider area onto the scanning mechanism 124 than if such features were not included.

FIG. 5 depicts a close-up, side elevation view of the pressure tolerant window 108 and the first endcap 112, and further depicts some internal components of the subsurface lidar system 100, including components of the scanning mechanism 124. As shown in this example embodiment, the scanning mechanism 124 includes motor components 128 that can be press-fit into the first endcap 112. A single o-ring groove 130 is formed in portion of the first endcap 112 where a single piston o-ring is used to seal the first endcap 112 to the pressure vessel center section 120. Multiple o-rings and o-ring grooves could be used as opposed to a single o-ring and groove. By keeping the outer diameter (OD) of the window 108 smaller than the OD of the housing 104, additional protection is provided for the window 108, especially when inspecting pipelines or in downhole applications.

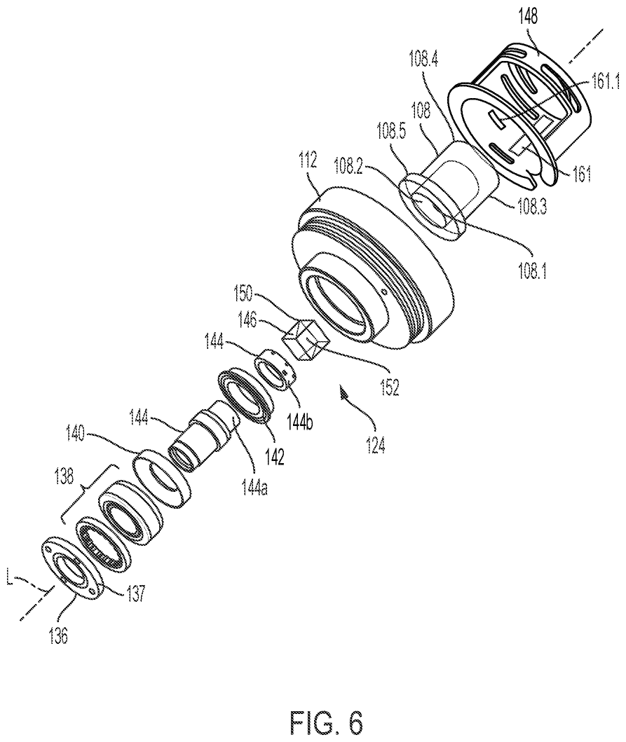

FIG. 6 depicts an exploded view of components of an embodiment of a submersible housing 104, including the pressure tolerant window 108, first endcap 112, and scanner mechanism 124. The components of the scanner mechanism 124 are disposed along, and centered on, a first axis, which can be coincident with a longitudinal axis L of the submersible housing 104, and generally include a ball bearing assembly 136 with one or more outer rings 137. The outer ring 137 functions to connect an associated outer race or cup of the bearing assembly 136 to an interior of the housing 104. In the illustrated example, the bearing assembly 136 is disposed along and centered on the longitudinal axis L of the housing 104, adjacent a motor 138. The bearing assembly 136 generally supports the scanning mechanism 124 components, such as a shaft 144 and a reflector 146. Thus configured, while in operation, the motor 138 rotates the scanning mechanism 124 components about the longitudinal axis L of the housing 104.

The outer ring 137 can contain features that act as a deflection reducer. For example, where the lidar system 100 is deployed in certain environments, such as deep ocean environments, the interior dimensions of the housing 104 can decrease. The outer ring or rings 137 included in embodiments of the present disclosure are therefore deflection reducing parts that are configured to accommodate changes in the distance between an outer diameter of the outer ring 137 and an inner diameter of the outer ring 137. As a result, the bearing 136, the shaft 144, and the attached reflector 146 or other optical components, remain properly located within the submersible housing 104. Given a high pressure and/or high temperature environment, a deflection reducing part can alleviate stress on the bearing 136. Stress on the bearing 136 can lead to more power draw and shorter bearing life. The outer ring 137 can have grooves, slots, holes, voids, etc., and high strength but low stiffness characteristics are optimal. In accordance with at least some embodiments of the present disclosure, the outer ring 137 is formed from a material that is more ductile than the housing 104. The deflection reducing outer ring 137 keeps the bearing 136 centered in the housing 104 so the deflection is symmetrical. A deflection reducing part can be used around the motor 138 too. The deflection reduction part can also reduce vibration.

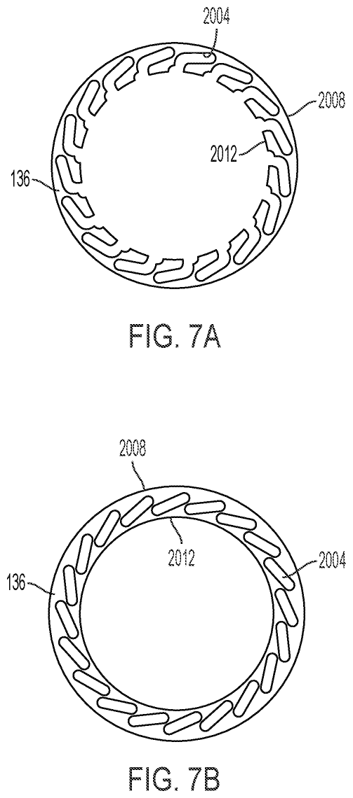

Examples of outer rings 137 having deflection reducing features in the form of slanted slots 2004 are illustrated in FIGS. 7A and 7B. In the illustrated embodiments, the outer rings 137 are flat, annular rings having an outer diameter 2008 sized to contact an inner diameter of the housing 104, and an inner diameter 2012 sized to receive an outer diameter of the shaft 144. In addition, each of these example outer rings 137 have a plurality of slots 2004. Each of the slots 2004 features two long edges that are parallel to one another, and that are at some angle other than 0 or 90 degrees to a radius of the outer ring 137. In the embodiment shown in FIG. 7A, one end of each slot 2004 is defined by a curved end portion, while the opposite end is open to the inner diameter of the outer ring 137. In the embodiment shown in FIG. 7B, the slots 2004 are all closed, with curved end portions connecting both of the long edges. In accordance with other embodiments, outer rings 137 can include combinations of open and closed slots 2004.

The motor 138 in accordance with embodiments of the present disclosure is a hollow-core motor and the shaft 144 is also hollow. This allows for light to pass along an axis of rotation of the motor 138, and through the center of the shaft 144 and motor 138. In addition, the shaft 144 in the illustrated embodiment can be provided in first 144a and second 144b parts. The motor 138 and bearing 136 are sealed so that no particulates can escape into the optical path. The motor 138 assembly is press fit into the first endcap 112. This reduces part-count and simplifies assembly. As opposed to press fitting, epoxy or pinning could be used. The motor 138 can be epoxied in, epoxied to a ring and the ring press fit, epoxied to a deflection reduction part with that pressed in, or the motor 138 can be clamped and held in place. In another embodiment the motor 138 assembly could be press fit into a separate housing that is then aligned and attached to the first endcap 112. A centering expansion spring can be included to reduce stresses, center the motor 138, and allow for disassembly and/or modifications.

The shaft 144 can be a two-part assembly where the “bonded end” 144b is separated from the “non-bonded end” 144a. This can improve assembly by allowing the use of smaller bearings that can't otherwise fit around the reflector 146. Additionally, the non-bonded end of the shaft 144 can be saved if bonding associated with the reflector 146 fails. Additionally, the bonded end can be positioned and held in place to optimize shaft balance during assembly.

As best shown in FIGS. 5 and 6, at least some embodiments of the present disclosure can include a window 108 disposed along and centered on the axis of rotation of the motor 138 and the scanning mechanism 124. The window 108 is generally cylindrical in form, with a first or open end 108.1 through which at least a portion of the reflector 146 is received into an interior volume 108.2. More particularly, the center axis of the window 108 cylinder is coincident with the axis of rotation of the motor 138. The window 108 in such an embodiment protrudes from the endcap 112, enabling an unobstructed, 360° view about the longitudinal axis of the submersible housing 104. At least a portion of the window 108 radially adjacent the interior volume 108.2 is a lateral transmissive portion 108.3. The end of the interior volume 108.2 opposite the open end 108.1 is closed by an end surface or portion 108.4. In at least some embodiments, the end surface 108.4 can function as a second transmissive portion. Where used as a transmissive portion, the end surface 108.4 can incorporate a lens element. In the embodiment depicted in FIGS. 5 and 6, the window 108 includes a base or flange portion 108.5 that surrounds the open end 108.1, and that has an outer diameter that is larger than the outer diameter of the lateral transmissive portion 108.3. In additional embodiments, the pressure tolerant window 108 is only a tube and does not have a flange. This is an easier window to manufacture. The tube type window 108 (i.e a variant without a flange portion) can still be bonded or sealed in any of the previously mentioned methods. In still another embodiment, the window 108 includes a flange 108.5 that has through-holes to allow the window 108 to be tightened to the endcap with bolts. This approach can then uses face-sealing o-rings as opposed to bonding to protect from water intrusion at pressure, however, any of the previously mentioned sealing methods can still be used.

The embodiment illustrated in FIG. 6 allows the window 108 to be bonded to the first endcap 112 first. All other components can be inserted from the other end. If the shaft 144 is press fit into the housing 104, a groove feature can be designed into the end of the shaft 144 so it can be clamped onto and all internals and pulled out if needed. The shaft 144 is press fit into the bearing 136 and the motor 138, which are themselves press fit into the housing 104. A spacer 140 can be used to assist pulling out the internals by, for example, protecting the exposed motor coils, wire routing, stiffening, clamping, etc.

In addition, FIG. 6 illustrates components of a lidar assembly 100 having a shroud 148 that partially surrounds the window 108. As depicted in FIG. 6, a calibration surface 161 can be formed on the interior surface of the shroud 148. The calibration surface 161 can be spaced apart from a side surface or lateral transmissive portion 108.3 of the window 108, and can present a surface having a known reflectivity. Moreover, that reflectivity can be constant across the full extent of the calibration surface 161. As can be appreciated by one of skill in the art after consideration of the present disclosure, the calibration surface 161 can thus enable the measurement of turbidity or index of refraction of the water surrounding the window 108.

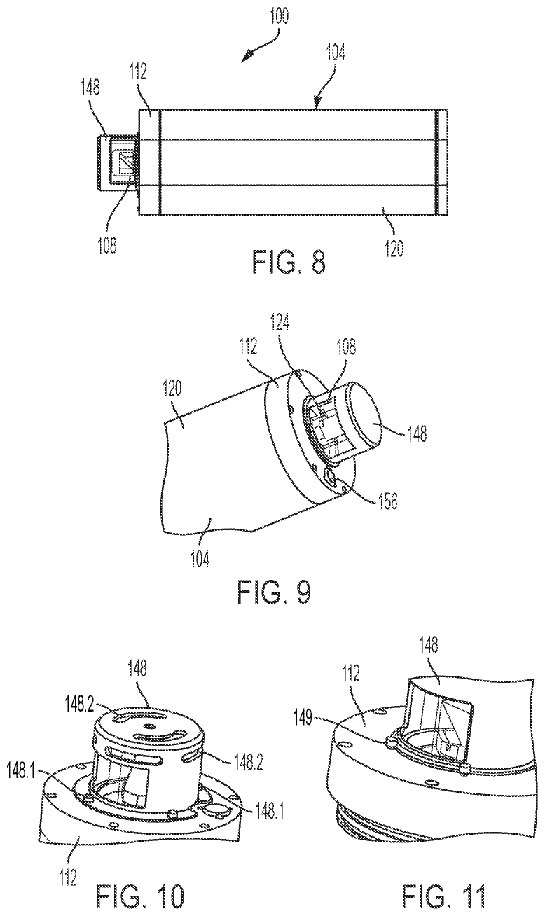

FIG. 8 depicts an embodiment of a subsurface lidar system 100 having an underwater housing or pressure vessel 104 with a pressure tolerant window 108 and a shroud 148 to protect the window 108 and to limit the field of view to less than 360°. The shroud 148 serves several purposes. First, it physically protects the window 108 from bumps, drops, and outside forces. Second, it limits the field-of-view to a desired area. Third, it provides eye-safety protection for the field of view that is not of interest. For instance, if the scan area is facing down in a nuclear reactor pool, the shroud 148 prevents the laser from pointing directly up out of the pool where people are located and an eye safety concern could be present. FIG. 9 depicts a close-up of the embodiment of FIG. 8, and in particular depicts the pressure tolerant window 108, a portion of the scanning mechanism 124, and the protective shroud 148. A laser safety light 156 is also shown. The safety light 156 provides multiple purposes. First, it blinks a color and/or pattern (for instance fast red blink) when the laser is active. This is often a requirement for laser systems. Second, it can blink in different colors or patterns for informational purposes. For instance, it could blink green when the lidar system 100 is powered, initialized, and ready for operation. It could blink orange when it has power but does not have communications established. It could blink orange but at a different blinking pattern when it is powered and in the middle of initialization. Any other number of color and blink patterns could be used as visual indicators of the state of the optical head. The safety light is also a pressure tolerant design.

FIG. 10 depicts a close-up of an embodiment of the protective shroud 148. The embodiment illustrated in FIG. 10 depicts an installation in which the shroud 148 slides into a groove in the endcap 112. In this embodiment, the shroud 148 installs in only one orientation so the field of view can be precisely controlled with respect to the rest of the housing 104. Alignment features 148.1, such as pins, holes, and slots, can be used for precise alignment. This can be advantageous for precisely aligning the shroud 148 and field of view with other alignment features on the endcaps 112 and 116 or tube 120 that are used for mounting of the scanning mechanism 124 of the submersible housing 104. Therefore, when mounting the submersible housing 104 on a plate or vehicle, the field of view in relation to the vehicle can be known and controlled. The holes or slots 148.2 in the shroud 148 allow for the venting of trapped air or bubbles. Air is often trapped in any crevice when transitioning from air to below the water surface. The slots are strategically placed so they do not fall in the field of view of the beam while it spins 360° to maintain the beam block or eye safety feature of the shroud 148. The shroud 148 may be of different colors (such as black) to maximize absorption of the laser light for eye safety purposes. Additional internal features, such as but not limited to ledges or blocks can be added to the inside of the shroud to provide additional beam blocking and eye safety protection.

Other additional features can be added inside the shroud 148 such as precisely controlled ledges 161.1 (see FIG. 6) that can be used to perform calibration activities with a controlled and known amount of fluid path between the output window and the backstop. These include, but are not limited to: measurement of index of refraction with time of flight or angular deviation (as described in U.S. Pat. Nos. 8,184,276 and 8,467,044), turbidity, particulate size, shape of particulates and flow rate, optical alignment measurement and adjustment such as determining how far off the center of rotation the reflector 152 actually is mounted and then adjusting measurement(s) of both angles and distance with that measured offset. Modifying the reflective properties and having a known backstop also allows for measuring the precise laser power delivered to the target, after traveling through a known amount of fluid, and allows variable gain lasers to be adjusted for actual sensed laser power; this can be verified on each rotation of the reflector 152 and automatically adjusted for by the software no matter what the changing conditions of the liquid properties so that an optimum amount of return signal is achieved in the detector. If the scanning medium was sensitive to laser power, that could also be used to adjust power delivered. If a multi-spectral laser or multiple lasers of different wavelengths are used, the return light off of the calibrated target can be used to analyze absorption over spectra thus allowing chemical and thermal properties of the fluid.

FIG. 11 depicts a close-up of a different embodiment of the protective shroud 148. In this embodiment the shroud 148 can rotate freely 360° relative to the end cap 112 before clamping down with screws 149. In this embodiment the shroud 148 sits on top of the end cap 112. In a different embodiment the shroud 148 could fit inside a small groove. The shroud 148 can include slots for venting trapped air while providing beam blocking for eye-safety purposes. The shroud 148 can be quickly swapped for a different shroud 148 with a different sized opening, or not used at all.

In an additional embodiment the shroud 148 could be free-rotating so the opening always faces in the desired orientation, for example, open slot down no matter the orientation of the submersible housing 104. This is achieved by less dense material on top, and denser material and/or a counter weight on the bottom for a desired orientation which is free to rotate with orientation changes from gravity, with or without the sensor being in a fluid.

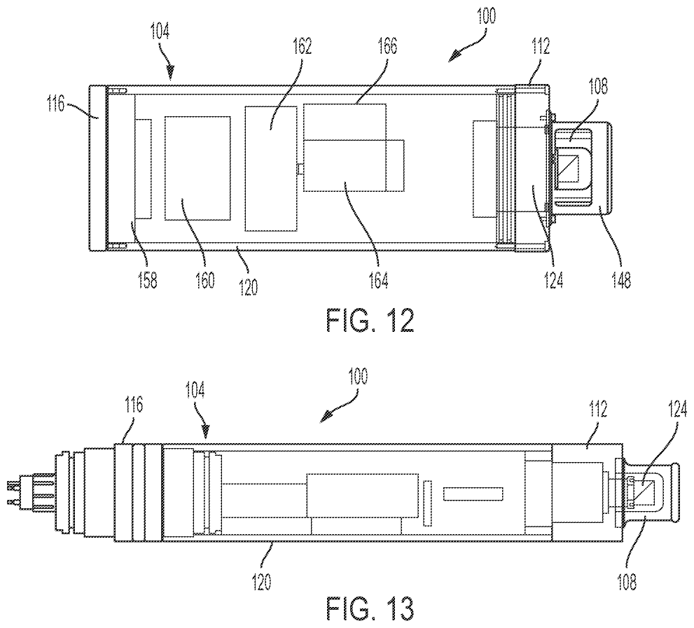

FIG. 12 depicts aspects of a submersible housing 104, including components that can be disposed within an interior of the submersible housing 104, and is an example of a complete or self-contained pressure tolerant 360° scanning optical system or lidar assembly 100 in accordance with another exemplary embodiment of the present disclosure. The housing 104 of the lidar system 100 is shown in a cut-away, longitudinal cross-sectional view, so that various internal components are visible. The end of the housing 104 opposite a first endcap 112 can be sealed by a second endcap 116. Components that can be disposed within the interior volume of the housing 104, which is generally defined by the first endcap 112, the second endcap 116, and the center section 120, include a power board 158, a central processing unit (CPU) 160, laser electronics 162, a laser or other light source 164, a receiver 166, and a scanner assembly 124. In this embodiment, a window 108 is included as part of the first endcap 112. In addition, a shroud 148 can be disposed about endcap 108, defining a field of view that extends for less than 360°.

FIG. 13 is an example of a submersible housing 104 of a complete pressure tolerant 360° scanning optical system or lidar assembly 100 in accordance with still other embodiments of the present disclosure. This example has the same components as the embodiment depicted in FIG. 11, however the shroud 148 is eliminated to allow for complete 360° viewing. This is ideal for pipes, tunnels, and downhole applications where a 360° field of view is desired.

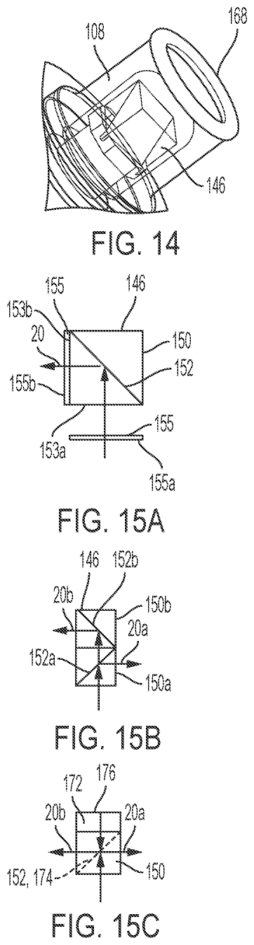

FIG. 14 is a close-up, perspective view of an embodiment of a pressure tolerant window 108. In this example, a “bumper” 168 is bonded to the top of the window 108 to provide protection against bumps, scrapes, drops, and impacts. The bumper 168 can be rubber, plastic, or another material that can act as a barrier between the window 108 and other objects. A metal cap can be included (for instance, bonded) onto the bumper 168 that provides protection along the entire top surface. In another embodiment the metal cap extends partway down the sides along with another rubber “o-ring”. The metal cap stops above the field of view so as to not block any portion of the 360° field of view provided by the window 108 in this embodiment.

As can be appreciated by one of skill in the art after consideration of the present disclosure, in operation, the light source 164 outputs a beam of light that travels along the first axis (which can correspond to the longitudinal axis L of the submersible housing 104) through a center of the motor 138, bearing 136, and shaft 144, to the reflector 146. The reflector 146 causes the beam to be directed through the transmissive lateral surface 108.3 of the window 108. In accordance with at least some embodiments of the present disclosure, the reflector 146 directs the beam of light along an angle that is about 90° from the first axis, although other angles are possible. In addition, the rotation of the reflector 146 imparted by the motor 138 causes the beam to rotate or scan about the first axis. Where there are no obstructions, the scan angle can traverse a full 360° about the first axis. Alternatively, for example where a shroud 148 is provided, the scan angle can be some amount less than 360°.

The reflector 146 included in the scanner assembly 124 can be configured as a mirror or prism. Moreover, the reflector can be single or multi-faceted. A multi-faceted system enables scanning of a single field of view multiple times per rotation. Alternatively, in a 360° system, multiple beams could be used in combination with multiple facets to enable simultaneous scanning of different fields of view with the 360°. In at least some embodiments, the reflector 146 is a standard plate mirror mounted in a housing that is attached to the shaft 144. This could be a metal or glass mirror with a dielectric coating for optimal reflection. With this architecture the mount is preferably designed to allow for the appropriate clear aperture while maintaining a balanced load for the spinning shaft 144. Another embodiment of the reflector 146 is a simple right-angle prism where the external angled face has a metal or dielectric coating. An issue with this latter approach is the prism is not balanced for the spinning shaft 144. The embodiment of the reflector 146 illustrated in FIG. 15A includes a mirror or reflector surface 152 disposed internal to a cube 150 of glass or other transparent material that provides a single facet that provides a reflector surface and that allows for simple centering and balancing of the load on the shaft 144, as opposed to a configuration using a right-angle prism. The internal angled facet or reflector surface 152 of the reflector 146 reflects the outgoing light approximately 90° from the center of the shaft 144 to output through the side or lateral transmissive portion 108.3 of the window 108.

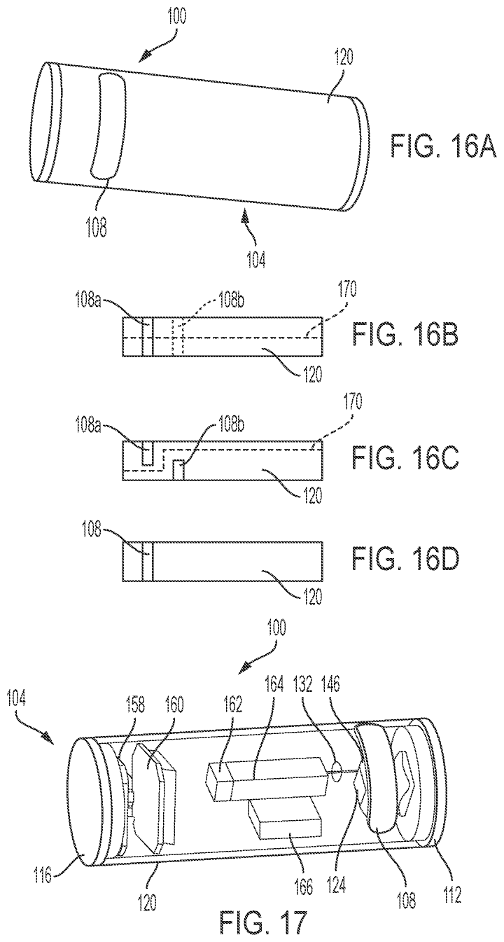

In accordance with at least some embodiments of the present disclosure, the reflector 146 directs the light at an angle of other than 90° from the central or rotating axis of the scanning assembly 124. A reflection angle of +/−˜5° from 90° can reduce the back-reflection of light from the window 108 back onto the detector for a monostatic system. Another method of reducing back-reflections is the fast shutter described later. The input 153a and output 153b surfaces of the cube 150 or prism are coated with an anti-reflection coating to minimize back-reflections from those surfaces. The internal reflecting surface 152 can be a metal or dielectric reflector. In accordance with other embodiments of the present disclosure, the reflecting surface 152 can be polarization selective where (for instance) light of s-polarization is reflected while light of p-polarization is transmitted through the cube 150. In accordance with other embodiments of the present disclosure, the angled reflecting surface 152 can be dichroic, where one wavelength is reflected while another wavelength is transmitted. This is advantageous where 360° scanning is required but the window 108 must be mounted along the center section 120 and not on the end, as in the embodiments illustrated in FIGS. 16A-16D and 17. In this scenario, power and signal wires can be passed on though the scanning area, but are routed around the window 108, so as to not block the field of view. In such an embodiment, two windows 108a and 108b are required, as shown in FIGS. 16B and 16C. Where two windows 108a and 108b are provided that are spaced apart from one another along the longitudinal axis of the housing 104, the reflector 146 can be configured with two reflector surfaces 152 that are axially separated from one another, as illustrated in FIG. 15B. In this configuration, a single scanner assembly 124 can scan through both of the axially separated windows 108a and 108b. A scanning mechanism 124 that is able to transmit and receive light through two axially separated windows 108a and 108b can be achieved by using polarization selection, frequency selection (dichroic), or simple power splitting.

The ability to scan using two separate reflectors 146 in the same scanning mechanism 124 can also enable faster scanning over a given angle of view. For example, when scanning the seabed over a 150° angle of view, providing two separate reflective surfaces 152 results in two separate data collections over the 150° angle of view for every single rotation of the scanning mechanism 124. In the example reflector 146 of FIG. 15B, the reflector 146 includes a first cube 150a that is stacked with a second cube 150b. The reflector surface 152a of the first cube 150a is configured to reflect light of a first wavelength as a first transmitted beam 20a, and to pass light of a second wavelength to the second cube 150b. The light of the second wavelength is then reflected by the reflector surface 152b of the second cube 150b as a second transmitted beam 20b. As an example, but without limitation, the reflector surface 152a of the first cube 150a can be provided as a dichroic element. This configuration of two stacked cubes 150 allows for two data collections for every single rotation of the scanning mechanism 124, thereby allowing for faster vehicle speeds for the same data collection density. In accordance with further embodiments of the present disclosure, more than two cubes 150 could be stacked to allow for multiple lines per rotation. For instance, four cubes 150 could be stacked, each outputting light along lines that are orthogonal to each other. Such an embodiment can be implemented using lasers or other light sources 164 that emit, natively or in combination with associated filters, light of four separate wavelengths, and the use of filters arranged and selected to each pass a selected one of the four wavelengths to an associated receiver.

In accordance with further embodiments of the present disclosure, an embodiment with stacked beam cubes 150 as shown in FIG. 15B can include a first cube 150a having a reflector surface 152a that is configured to reflect light of a first polarization as a first transmitted beam 20a, and pass light of a second polarization to the second cube 150b. The second cube 150b includes a reflector surface 152b that fully reflects the light of the second polarization as a second transmitted beam 20b. This can be accomplished by including a polarization rotator between the two cubes 150 or that is coated onto one of the surfaces of the two cubes 150 to rotate the transmitted polarization to the orthogonal polarization for reflection at the second reflector surface 152b. This allows for two data collections for every single rotation of the scanning mechanism 124, thereby allowing for faster vehicle speeds for the same data collection density. The polarization and dichroic methods could be combined if desired.

In accordance with still further embodiments of the present disclosure, simple power splitting can be used. In such an embodiment, each cube 150 includes a partially reflective reflector surface 152, which reflects a portion of the light, and transmits a remaining portion of the light to a next cube 150, or to enable forward scanning. This approach can have more loss than the dichroic or polarization approaches, but is still a viable option.

An example of a scanning mechanism 124 capable of simultaneously directing separate beams of light in accordance with other embodiments of the present disclosure is illustrated in FIG. 15C, which incorporates a single polarization selective beam splitter or cube 150 having a first reflector surface 152 configured as a polarization selective reflector surface 174, and a quarter wave plate 172. As an example, light of a first polarization (e.g., s-polarization) is reflected at the polarization selective reflector surface 174 while light of a second polarization (e.g., p-polarization) is transmitted. The reflected light forms a first beam 20a. The transmitted light of the second polarization is converted to circular polarization by the quarter wave plate 172. The circularly polarized light is then reflected by a mirrored surface 176 adjacent to the reflector 174 and along the axis of rotation of the scanning mechanism. The reflection from the mirrored surface 176 reverses the circular polarization and another pass through the quarter wave plate converts the light to the first polarization so it now reflects from the polarization selective reflector surface 174 as a second beam 20b, in a direction opposite the direction in which the first beam 20a is reflected. This allows for two data collections for every single rotation of the scanning mechanism 124, thereby allowing for faster vehicle speeds for the same data collection density while using less components and mass.

With reference again to FIG. 15A, a corrective optic 155 can be provided to correct for the bending of the light caused by the curved pressure tolerant window 108. The corrective optic 155 can be made from any standard optical material (glass, plastic, crystal). In accordance with at least some embodiments of the present disclosure, the corrective optic 155 is mounted inside and at either end of the hollow shaft 144 of the motor 138 so it rotates with the mirror 146 (depicted as corrective optic 155a in the figure). Alternately or in addition to a corrective optic 155a mounted to the hollow shaft 144, a corrective optic 155b can be disposed on one or both of the surfaces 153a and 153b of the mirror. In accordance with still other embodiments of the present disclosure, a corrective optic 155 is imprinted directly on one of the surfaces of 146 so the weight and alignment requirements of an additional optical element is avoided. The corrective optic 155 can be made into a diffractive optical element, Fresnel lens, meta-optical element, or computer generated hologram so it is thin and has less mass.

In any of the reflector 146 configurations, return signals 22 can be received through the same pathways used to transmit signals 20. In particular, a return signal passing through the window 108 that is incident on the reflector 146 can be directed by the reflector surface 152 down the first axis, through the bearing 136, shaft 144, and motor 148, and can then be directed to a receiver 166 by a beamsplitter as described elsewhere herein. Accordingly, the scanning mechanism 124 can be bidirectional.

FIG. 16A is an example of a complete pressure tolerant housing 104 of an optical scanning system or lidar assembly 100 in accordance with embodiments of the present disclosure with a reduced field of view and with an optical window 108 that is mounted in an aperture formed in the sidewall of the pressure vessel center section 120. This architecture does not allow for 360° viewing, but can allow for a wide field of view, for instance 150°. One advantage of this architecture is the window 108 is better protected since it is not sticking out of one end of the housing 104. The primary advantage of this architecture is when 360° field of view is not required, however power and communication cables or other hardware must be passed from one end of the housing 104 to another, or if the housing 104 is simply a module in a chain of tools and sensors that are connected together mechanically and electrically. In these instances a 360° view is difficult with a single window 108. Multiple innovative approaches can handle this type of architecture.

As illustrated in FIGS. 16B and 16C (where FIGS. 16B and 16C are views of the same lidar assembly 100 rotated about the long axis by 90 degrees relative to one another), the center section 120 of the housing can include two or more windows 108 that are disposed so as to extend about different portions of an external diameter of the center section 120 and that are axially offset from one another along a length of the center section. For example, two windows 108a and 108b can be provided that extend radially for >180° (for instance 200° to allow overlap radially), and that are offset axially along the length of the center section 120. Power, data, and communication cables 170 can then be routed from one side of the tube 120 to the other to avoid obstructing the optical field of view. A stacked cube scanner mechanism 124 as described in connection with FIG. 15B above could be used to scan through the two separated windows 108a and 108b using a single scanner mechanism 124 assembly. In an alternate embodiment the windows 108 are actually full 360° tubes as opposed to <360°, however a reduced field of view is used. This allows for easier and less expensive manufacturing of the windows as the transparent tube of such windows 108 does not have to be cut to a particular window shape or size.

In another embodiment of the present disclosure, the enclosure 104 features a single 360° window mounted in the tube, as illustrated in FIG. 16D. In order to pass power, signals, and communications past the window 108 without obstructing the 360° field of view, signals and communications can be converted to wireless signals that are transmitted internally past the window 108. Power could also be transmitted wirelessly, however this could cause interference with signal and communication transmission and can be lossy, which is undesirable in battery powered devices. Another option is to pass electrical current/power through an optically transparent material. One example is a layer of indium tin oxide (ITO) on a substrate such as glass. For instance, an inner tube of glass could be created with ITO layers on the glass for electrical power and ground. The glass substrate can be a tube itself that fits inside the pressure window 108 and therefore would experience no stress from pressure changes. The glass substrate is optically clear, thin, and a continuous surface within the optical 360° field of view in order to minimize aberrations and other impacts on the optical system.

In an additional embodiment, an internal cylindrical optical component is used between the scanner and the output window. This optic consists of multiple optical fibers or etched optical channels that route around cable through-holes in the optic. A single or multiple channels are used for the output beam. Multiple channels are used for the receive path.

FIG. 17 depicts aspects of a submersible housing 104 in accordance with other embodiments of the present disclosure, and is an example of a complete pressure tolerant scanning optical housing 104 where a window 108 is mounted in the center section 120. The submersible housing 104 of the lidar system 100 is shown in a cut-away, longitudinal cross-sectional view, so that various internal components are visible. The housing 104 includes a center section 120, a first pressure tolerant endcap 112 at a first end of the center section 120, and a second pressure tolerant endcap 116 at a second end of the center section 120. A power board 158, central processing unit (CPU) 160, laser electronics 162, laser or other light source 164, receiver 166, and scanning mechanism 124 can be disposed within an interior of the housing 104. In this embodiment, the scanning mechanism 124 is mounted on one side of the window 108 and the laser 164, receiver 166, and optical system 132 are mounted on the other side of the window 108. With this architecture power, signal, and communication signals must be passed from one side of the window 108 to the other without obstructing the optical field of view. This is achievable when the field of view is less than 360°. If the field of view is 360° then techniques like those described above can be employed.

The temperature of electronic devices, including but not limited to discrete devices such as processors, receivers, and sensors, and printed circuit boards must be maintained below a required temperature which may be a challenge within harsh environments where external temperatures of the housing are elevated. In accordance with embodiments of the present disclosure, a heat pump is provided to achieve the required operational range of the electronics. A heat pump such as a Peltier module is an option but requires careful design consideration.

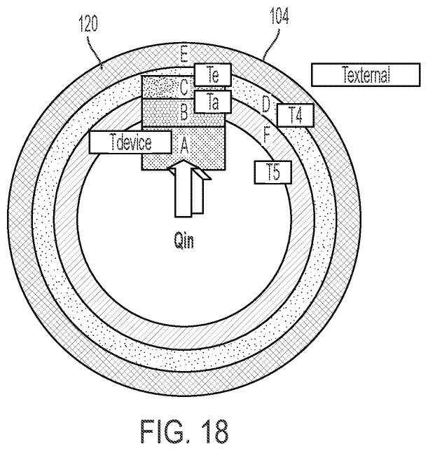

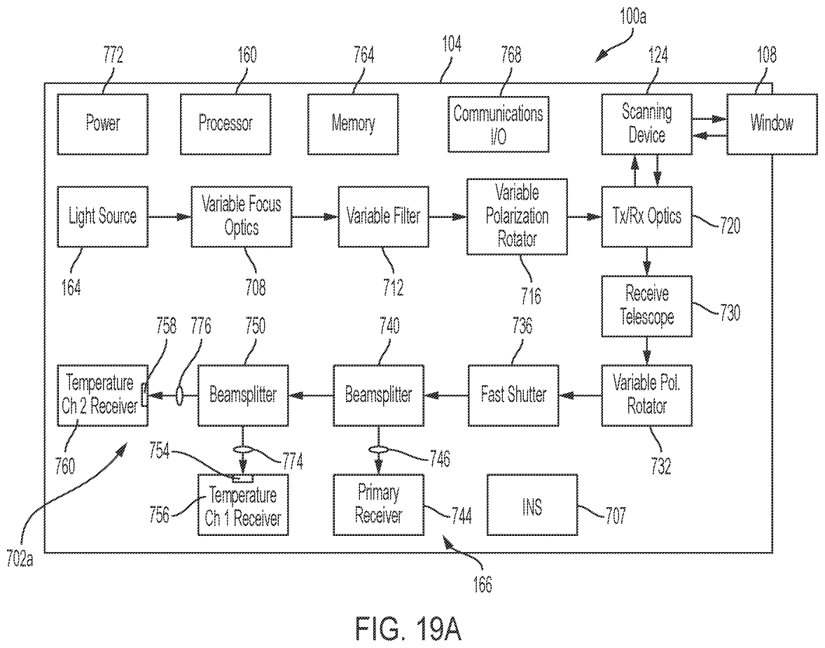

FIG. 18 shows a conceptual depiction of a cross section of a circular cylinder metal center section 120 of a submersible housing 104 in accordance with at least some embodiments of the present disclosure. The environment surrounding the submersible housing 104 has an elevated temperature of Texternal. The electronic or optoelectronic device within the submersible housing 104, labeled “A”, such as a CPU 160, light source 164, receiver 166, printed circuit board, and the like, is a heat generating component that must be maintained below a temperature Tdevice. Note that in extreme environments Texternal>Tdevice, so sinking heat into the environment must be carefully designed. A thermally conductive path B connects the device A to a Peltier heat pump C. The outermost layer, labeled E in the figure, can form the structural member or component of the center section 120 of the submersible housing 104. In thermal contact with the heat pump C, and extending across all or most of an interior surface of the outermost layer E, is a heat spreader D. Thermal insulation F surrounds the heat generating device A that is cooled by the heat pump C. In accordance with at least some embodiments of the present disclosure, the interior of the heat spreader D, and any interior surfaces of the outermost layer E not covered by the heat spreader D can be covered by the thermal insulation F.

The device A is electrically driven and produces heat Qin. The device has an interface through a good thermal conductor with a thermal resistance presented by the thermally conductive path B. Its thermal resistance is inversely proportional to the surface area in contact with the Peltier heat pump C. The heat pump C is powered by current, which results in a cooling effect surface area near the device A, and heats up the surface area opposite the heated device A according to a mechanism referred to as the Peltier effect. The heated side is physically connected to the heat spreader D to distribute the heat as efficiently as possible to the external layer E of the housing 104. Though the housing 104 in this example is metal, its properties may be optimized for pressure rating rather than heat conductance, thus the need for heat spreading. The temperature at the external side of the Peltier heat pump C is greater than the external environment temperature Texternal, thus heat flows out of the submersible housing 104, into the environment.

Unfortunately, thermal energy can flow back to the element through a different physical pathway thereby creating a thermal short circuit. A Peltier heat pump provides a cooling effect at the interface of the heat generating device A, but it also creates heat as the amount of power delivered to the module increases. To eliminate this issue, the heat generating device A must be completely insulated (like a thermos as shown in FIG. 18) to stop the thermal short circuit or cutting off the pathway back to the device A being cooled. The insulation F thermal resistance is made to be very large (very low thermal conductance) thereby not allowing any thermal pathway back to the device A being cooled. Careful design of thermal conduction paths and insulation is required to force heat flow in the desired directions to enable operation in high external temperature environments.

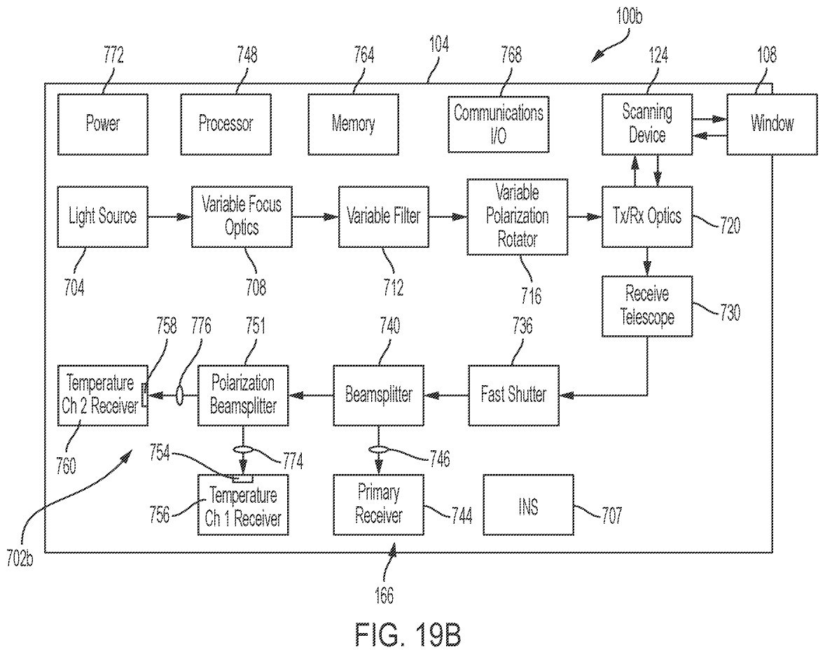

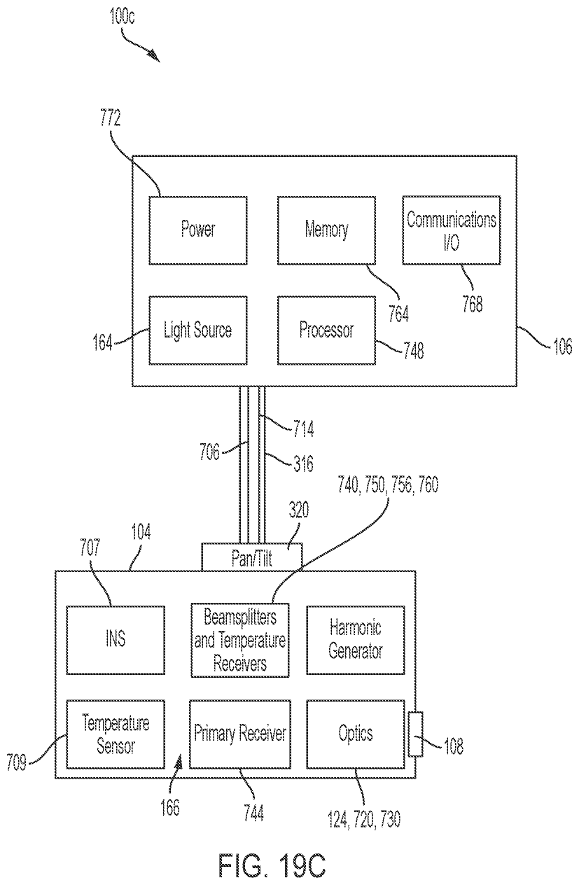

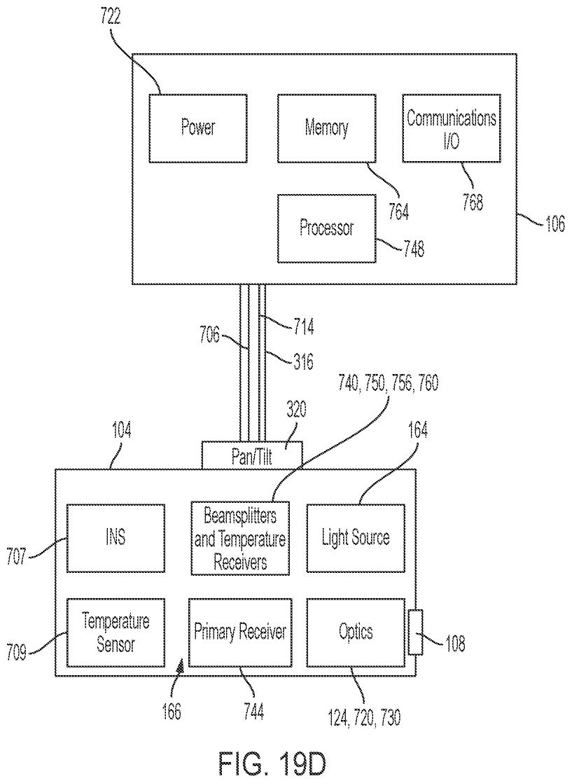

FIGS. 19A through 19D illustrate components of exemplary lidar systems 100 in accordance with embodiments of the present disclosure in block diagram form. In accordance with at least some embodiments of the present disclosure, the components of the lidar system 100 are disposed entirely within a common vessel or enclosure in the form of the submersible housing 104 (see, e.g., FIGS. 19A and 19B). The lidar systems 100 of FIGS. 19A and 19B differ from one another in that the embodiment of the lidar system 100a illustrated in FIG. 19A includes an optional temperature measuring sub-system 702a that compares a ratio of Raman wavelength amplitudes within a return signal to measure temperature, while the lidar system 100b illustrated in FIG. 19B includes an optional temperature measuring sub-system 702b that calculates a ratio of light in the return signal based upon polarization to measure temperature. In accordance with other embodiments, at least some components are disposed within a separate enclosure or control box 106, while other components are disposed within an underwater optical housing or submersible housing 104 configured for underwater operations (see, e.g., FIGS. 19C and 19D). Accordingly, the monitoring systems 100c and 100d of FIGS. 19C and 19D differ from the monitoring systems 100a and 100b of FIGS. 19A and 19B in that the components of the lidar systems 100c (FIG. 19C) and 100d (FIG. 19D) are divided between a control system 106 and a submersible optical housing 104. Otherwise, the lidar systems 100a-100d generally share components in common and can perform the same types of measurements. Accordingly, except where noted, the following description applies to all of the embodiments of FIGS. 19A-19D.

The lidar system 100 in accordance with embodiments of the present disclosure can be implemented as an optical metrology or inspection system. As can be appreciated by one of skill in the art, a lidar system 100 is an active optical system that operates by transmitting light towards a target, receiving reflected light from the target, and determining the range to the target based upon time of flight information determined from the amount of time elapsed between the transmission of light from the light source and the time at which the reflected light or return signal is received at the receiver. As used herein, a target can include but is not limited to any area or feature on an underwater structure or pipe interior, including manmade structures and natural features or structures, 3-D targets mounted to an underwater structure, and 2-D targets applied to an underwater structure. In addition, the lidar system 100 generally operates to determine the location of a point on the target from which light is reflected located relative to the lidar system 100 in three-dimensional space by combining the range information with the known azimuth and elevation information via scanner mechanism 124 location (e.g. as an azimuth angle and an elevation angle) or pixel location for lidar systems 100 having a receiver 166 including a receiver or sensor 166 having multiple pixels, or a combination of the two. The location of point data collected by the lidar system 100 can further be geolocated or located relative to a local reference. The fourth dimension, time, is also recorded to enable measurements and features to be compared over time.

The components of the lidar system 100 thus include a light source 164. The light produced by the light source 164 can be collimated or variably focused by variable focus optics 708. Alternately it can be directly coupled into an optical fiber delivery system and then collimated or variably focused by optics. In accordance with at least some embodiments of the present disclosure, the light source 164 is a pulsed beam laser. As can be appreciated by one of skill in the art after consideration of the present disclosure, the light source 164 can produce light having a selected wavelength or range of wavelengths. As an example, but without limitation, the light source 164 may comprise a blue-green laser light source. As a further example, the light source 164 may have an output centered at 532 nm, 450 nm, or 660 nm. Other wavelengths can also be used, for example to optimize performance in response to various water conditions. For instance, in highly turbid water red wavelengths can have better performance at short ranges compared to blue wavelengths. In accordance with still other embodiments, the light source 164 may produce non-collimated light. In accordance with still other embodiments, the light source 164 may be a light emitting diode (LED) based, continuous wave (CW) laser based, modulated CW based, structured light, or some other light source.

The variable focus optics 708 can include traditional mechanical focusing elements and lenses, or non-mechanical elements, such as may be provided by fluid lenses, liquid crystal devices, polarization gratings, electro-optic devices, and other optical elements. The ability to focus the beam produced by the light source 164 can be used to optimize signal return for a specific target at a specific range for specific water conditions. It can also be used to increase final image resolution by reducing the laser spot size at the target of interest. The light can then be adjusted in magnitude by a variable filter or attenuator 712. This is advantageous for underwater sensing as the attenuation of seawater or other water bodies can vary dramatically, thus dramatically changing the return signal, which can strain the dynamic range of the receiver 166. In addition, when scanning a flat surface at large angles, the line-of-site distance can change significantly, which in turn can significantly change the return signal power. One method for reducing the required dynamic range of the receiver is to adjust the light output power from the transmitter. This can be achieved by the variable attenuator 712. As examples, the variable attenuator 712 can include standard neutral density filters, other attenuation filters, an optical fiber switch, liquid crystal devices, electro optical devices, or polarization elements. Alternatively, the power of the laser or pump diodes can be adjusted to modify the transmitter output power. When scanning a flat surface at large angles, the ability to adjust the optical output power during the scan can decrease the required dynamic range of the receiver 166. This can be achieved with liquid crystal based variable attenuators, polarization components or adjusting the driver current to the transmitter or light source 164.

In addition to the light source 164 and the variable focus optics 708, the optical train can include a variable polarization rotator 716. It is known that the polarization of the transmitted light 20 can affect the backscatter power, which is a source of noise at the lidar system 100 receiver 166. Transmission range can therefore be optimized by adjusting the polarization rotation of the output light. In addition, when performing nondestructive examination (NDE) inspections of welds or other fine features of metal objects, polarization adjustments of the transmitted light 20 and reflected or received light 22 can increase the contrast of any defects. In the lidar system 100a of FIG. 19A, in which a ratio of the amplitude of different selected wavelengths within a return signal is used to measure temperature, the variable polarization rotator 716 can impart any polarization to the output light. In the lidar system 100b of FIG. 19B, the variable polarization rotator 716, if included, can provide either a left hand circular or right hand circular polarization (in combination with a quarter wave plate), as some type of circular polarization is needed in order to compare polarization ratios in a return signal for temperature measurement in that embodiment.

The optical train can also include transmit and receive (Tx/Rx) optics 720, which are used to make the lidar system 100 monostatic. In accordance with embodiments of the present disclosure, the Tx/Rx optics 720 include a beamsplitter that directs light from the laser to the scanning mechanism 124 for transmission, and that directs received light to the receive telescope 730 for delivery to the receiver 166. Monostatic systems have the distinct advantage of simplified scanning, as the transmitter and receiver are pointed at the same location with the same scanning mechanism 124, resulting in calibration and reliability performance that is superior to bistatic systems.

The scanning device or mechanism 124 can then be used to accurately direct the transmitted beam 20 and the field of view of the receiver 166 simultaneously to a scene through a window 108 in the submersible enclosure 104. The scanning mechanism 124 can include rotating cubes 150 incorporating reflective or selectively reflective surfaces 152 to enable scanning of a transmitted beam across a wide field of view, and the reception of a return signal from within that same field of view. The scanning mechanism can further include corrective optics 155. The scanning mechanism 124 can also include a steering mirror (such as galvanometer or spinning polygon mirrors), or other beam steering device, such as Risley prisms, a micro-electro-mechanical system (MEMs), liquid crystal, liquid crystal meta-surfaces, acousto-optic, optical phased array (OPA), serpentine OPA, electro-optic device, one or two-axis fast steering mirror, or any combination thereof, for precise control of the pointing of the light source 164 and receiver 166 toward a target, such as an underwater structure, and at known angles relative to the lidar system 100.

In an additional embodiment, the scanning mechanism 124 can include a wide-angle receiver that does not scan but views the entire area in a single Field of View, while the output beam 20 only is scanned. The advantage of this approach is the output beam is a much smaller area than the receive aperture, so a smaller scanning system can be used. For the 360° field of view this can include a fish-eye type lens. Another concept is to use a 360° array of waveguides or light pipes, such a fiber optic bundle with lenses) that collect all light around the 360° surface and focuses them to a single, 1-D array, or 2-D array of detectors.

Light reflected from the target is received by the scanning mechanism 124 and is split by the beam splitter element included in the Tx/Rx optics 720. Light from the Tx/Rx optics 720 is provided to a receive telescope 730, which is configured to focus the received light so that it can be imaged onto the sensor elements of the receiver 166, which as discussed elsewhere herein can include one or more distinct receiver 744, 756, and/or 760. In embodiments of the lidar system 100 that include a wavelength based temperature measuring sub-system 702a, a variable polarization rotator 732 can be used to optimize the signal-to-noise ratio (SNR) of the return signal 22 by selecting the optimal polarization for the hard target return. In the lidar system 100b that includes a polarization based temperature measuring sub-system 702b, the variable polarization rotator 732 is omitted.

A fast shutter 736 can be provided to block any stray light from the primary beam (i.e. the transmitted or output beam 20) as it exits the window 108, after being directed by the scanning mechanism 124. The fast shutter 736 is timed with high speed electronics, which may be implemented by a processor 160, to block the window 108 reflection from a transmitted pulse 20 and then open quickly to capture returns 22 from close targets.

The light within a return signal 22 that is received through the window 108 and passed by the scanning device 124 and the beam splitter element of the TX/RX optics 720 is directed to the receiver 166. In accordance with embodiments of the present disclosure that include a temperature measurement sub-system 702, or that otherwise includes receivers in addition to a primary receiver 744, a beam splitter 740 splits off a portion of the return signal and directs it to the primary receiver 744. The beam splitter 740 may be in the form of a chromatic or achromatic beam splitter. For example, the beam splitter 740 may comprise a chromatic beam splitter that provides light at the primary wavelength output by the light source 164 to the primary receiver 744, and that provides the remaining light to the temperature measuring sub-system 702a or 702b. The primary receiver 744 can be used for range, vibration, and leak detection measurements made by the lidar system 100. As can be appreciated by one of skill in the art after consideration of the present disclosure, the receiver 166 can include only a primary receiver 744 and the beam splitter 740 can be omitted where the lidar system 100 does not include any receiver elements in addition to the primary receiver 744.

The primary receiver 744 includes an optical sensor or detector, such as a photodiode, an avalanche photodiode, a photomultiplier tube, a silicon photomultiplier tube, a Geiger mode avalanche photodiode, a multi-pixel photon counter (MPPC), a charge coupled device (CCD) detector, complementary metal oxide semiconductor (CMOS) detector, or other optical detector. It can also include an electronic amplifier and/or thermal control elements and circuitry. In addition, the primary receiver 744 can include or be associated with a narrow band filter to reduce background light. A focusing optic 746 can be included to focus light from the beam splitter 740 onto the sensor of the primary receiver 744. In accordance with embodiments of the present disclosure, the primary receiver 744 may comprise a single or multiple pixel sensor.

Information regarding the range to the target is monitored by the processor 160, which controls and/or has access to information regarding the time at which transmitted light 20 is output, and the time at which a return signal 22, comprising transmitted light 20 that has been reflected from a target, is received by the primary receiver 744. In addition, information from the scanning mechanism 124, including information regarding a radial angle of the scanning mechanism 124, from a pan and tilt head 320, and/or the location of a receiving pixel in a lidar device 100 or camera having a multiple pixel sensor, can be used by the processor 160 to determine the azimuth angle and elevation angle to the target. This information can then be combined with timing information, and in particular the time at which the transmitted pulse 20 of light produced by the light source 164 is sent towards the target, and the time that the return signal 22 is received at the primary receiver 744 to obtain range and angle, angle measurements. The range measurement determined from the timing information and the angle, angle information can then be applied to obtain a location of the target relative to the lidar system 100. As can be appreciated by one of skill in the art after consideration of the present disclosure, the primary receiver 744 also provides information regarding the intensity of the return signal 22, which can be analyzed in connection with determining, for example, whether the return is from an underwater structure, water, or a plume of fluid. Moreover, the intensity may be provided from the primary receiver 744 as a voltage signal.

The processor or CPU 160 can include any processor capable of performing or executing instructions encoded in system software or firmware stored in data storage or memory 764, such as a general purpose programmable processor, controller, Application Specific Integrated Circuit (ASIC), Field Programmable Gate Array (FPGA), System on Chip (SoC), RFSoC, or the like. Moreover, the execution of that software or firmware can control the operation of the lidar system 100, including the acquisition of point cloud data that includes azimuth angle, elevation angle, intensity, and range information taken from an underwater scene. The execution of the software by the processor 160 can be performed in conjunction with the memory 764, including the short or long-term storage of timing information, range information, point cloud data generated by the lidar system 100, control point locations, or other control information or generated data. The memory 764 can comprise a solid-state memory, hard disk drive, a combination of memory devices, or the like. The lidar system 100 can additionally include various sensors. For example, the lidar system 100 can include a conductivity, temperature, and depth (CTD) device for measuring the conductivity (and thus the salinity), the temperature, and the depth of the water at the location of the lidar system 100. Because a CTD device must be in direct contact with the surrounding water, it can be mounted outside of or adjacent an aperture in the submersible enclosure 104. As opposed to a CTD just a temperature sensor 709, such as a thermistor or resistance temperature detector (RTD), can be mounted to the submersible housing 104. This can be permanently mounted to an exterior of the housing 104, or can be mounted to a connector so it is removeable if damaged.

In addition, an inertial navigation system (INS) 707 or some part of an INS system, such as just an attitude sensor, can be mounted inside the submersible housing 104. The INS sensor 707 enables multiple added capabilities. First, it measures the angle of the submersible housing 104 to gravity so the data can be transposed to true gravity. Second, it measures any motion of the submersible housing 104 and that data can be used to compensate for that motion in post processing. This is important if the submersible housing 104 is deployed in a pipe, tunnel, or wellbore where the orientation and location cannot be tracked with GPS but must be reconstructed accurately.

As has been described in U.S. Pat. No. 4,123,160, the Raman return from water molecules can be used to determine the temperature of the water. Typically, this requires a full spectrometer to analyze the spectrum of the Raman return. In accordance with embodiments of the present disclosure, temperature measurements are performed by comparing two spectral channels or two polarization channels. Either of these approaches are allowed by a lidar system 100 in accordance with embodiments of the present disclosure that incorporates a temperature measuring sub-system 702a or 702b, as described herein.

Moreover, the temperature measurement subsystem 702a or 702b can measure the temperature of water at a distance from the lidar system 100. The temperature measurement subsystem generally includes a chromatic or achromatic beam splitter 750 (see FIG. 19A) or a polarization beam splitter (see FIG. 19B) 751 that divides the signal received from the primary beam splitter 740 into a first channel provided to a first temperature channel receiver 756 and a second channel that is provided to a second temperature channel receiver 760. First 774 and second 776 focusing optics can be included to focus light from the beam splitter 750 onto the respective temperature channel receivers 756 and 760.

In a lidar system 100a that includes a temperature measurement sub-system 702a that uses different wavelengths for temperature measurement (see FIG. 19A), the beam splitter 750 used to divide the return signal into two channels may comprise a chromatic or an achromatic beam splitter. A first one of the channels is passed through a first narrowband filter 754 before being provided to a first temperature channel receiver 756. A second one of the channels is passed through a second narrowband filter 758 before being provided to a second temperature channel receiver 760. The passband of the first narrowband filter 754 is selected to encompass a first Raman wavelength, while the passband of the second narrowband filter 758 is selected to encompass a second Raman wavelength. For example, where the transmitted light 20 from the light source 164 has a wavelength of 532 nm, the first passband can be about 10 nm wide and can be centered at a wavelength of about 640 nm, and the second passband can be about 10 nm wide and can be centered at a wavelength of about 655 nm, where “about” is +/−10% of the stated value. The temperature channel receivers 756 and 760 are optical detectors. The temperature channel receivers 756 and 760 can thus include a photodiode, CCD detector, CMOS detector, an avalanche photodiode, a photomultiplier tube, a silicon photomultiplier tube, a Geiger mode avalanche photodiode, a multi-pixel photon counter, or other optical detector. As a further example, the temperature channel receivers 756 and 760 can comprise single element or multi-pixel sensors. The temperature channel receivers 756 and 760 can also include an electronic amplifier, thermal control elements and circuitry, focusing optics, or other components. As can be appreciated by one of skill in the art after consideration of the present disclosure, the ratio of the amplitude of the signal comprising the first Raman wavelength detected at the first temperature channel receiver 756 to the amplitude of the signal comprising the second Raman wavelength detected at the second temperature channel receiver 760 gives the temperature of the water at a selected range and angular location.

In a lidar system 100b that includes a temperature measurement sub-system 702b that measures a ratio of differently polarized light for temperature measurement (see FIG. 19B), linearly polarized light from the light source 164 is passed through a first quarter wave plate, which can be located before or after the scanning mechanism 124 (but ideally after to reduce back reflections), to produce a circularly polarized output beam. A second quarter wave plate converts circularly polarized light in the return signal 22 to linearly polarized components. If the target reflection reverses the circular polarization, then a second quarter wave plate is not needed. A polarization beam splitter 751 then divides the portion of the return signal 22 received from the primary beam splitter 740 into two channels according to the polarization of the received light. A first one of the channels, comprising light of a first polarization (e.g. vertically polarized light), is provided to a first temperature channel receiver 756. A second one of the channels, comprising light of a second polarization (e.g. horizontally polarized light), that is opposite the polarization of the light in the first channel, is provided to a second temperature channel receiver 760. The temperature channel receivers 756 and 760 are optical detectors that receive one of the oppositely polarized signals. The temperature channel receivers 756 and 760 can thus include a photodiode, CCD detector, CMOS detector, an avalanche photodiode, a photomultiplier tube, a silicon photomultiplier tube, a Geiger mode avalanche photodiode, a multi-pixel photon counter, or other optical detector. As a further example, the temperature channel receivers 756 and 760 can comprise single element or multi-pixel sensors. The temperature channel receivers 756 and 760 can also include an electronic amplifier, thermal control elements and circuitry, focusing optics, or other components. As can be appreciated by one of skill in the art after consideration of the present disclosure, the ratio of the amplitude of the signal from the light of the first polarization detected at the first temperature channel receiver 756 to the amplitude of the signal from the light of the second, opposite polarization detected at the second temperature channel receiver 760 gives the temperature of the water at a selected range and angular location.

In addition, as can be appreciated by one of skill in the art after consideration of the present disclosure, the described Raman spectra based temperature sensing systems 702a and 702b of the lidar systems 100a and 100b depicted in FIGS. 19A and 19B can also be used to analyze and identify other targets of interest by selecting the wavelength bands of Ch1 receiver and Ch2 receiver, and of the light source 164. For instance, the spectra transmitted and received by the two receiver channels can be optimized to detect methane or other fluids and gases and therefore used as a leak detection system in a water environment. In addition, more than two channels can be used to further expand upon the ability and accuracy of the Raman spectra sensing.

One advantage of a lidar system 100 architecture in accordance with embodiments of the present disclosure is that the range and angle from the submersible housing 104 of the lidar system 100 to the target are known through the operation of the lidar system 100, so the thermal measurement can be optimized at particular points in space, thus improving the SNR for the thermal measurement and targeting the exact location of interest. For example, when the location (angle, angle, and range) of a hole or leak in a pipe relative to the lidar system 100 is known exactly, then a location within the water volume immediately adjacent to that exact location can be selected for the temperature or leak detection measurement by pointing a lidar system 100 at the location. Furthermore, the return signal can be gated to only receive a return signal 22 from a range corresponding to the selected location within the water, as opposed to the entire water path, thus improving the signal to noise ratio and reducing the amount of data processed. As another advantage, embodiments of the present disclosure provide for simultaneous or near simultaneous monitoring of movement, temperature, and leaks of an underwater structure using a single lidar system 100.

An additional advantage is the inherent ability to measure temperature along the water column. When imaging cooling or geothermal water in a pipe or downhole, the water column temperature can have a strong temperature gradient. The temperature gradient causes thermals (refractive turbulence) which causes distortions in any optical image and are clearly visible in camera images along with 3D images. Accurate knowledge of the index of refraction of the water is critical for accurate reconstruction of any 3D information. The index of refraction is known to change with wavelength, temperature, salinity, and pressure. A change in index will change the time it takes a pulse to travel to the target and back, and also changes the path of travel (angle) of the beam. This is all discussed in U.S. Pat. Nos. 8,184,276 and 8,467,044, the disclosures of which are hereby incorporated herein by reference. With range-gated knowledge of temperature along the beam path the 3D image can be more accurately reconstructed.

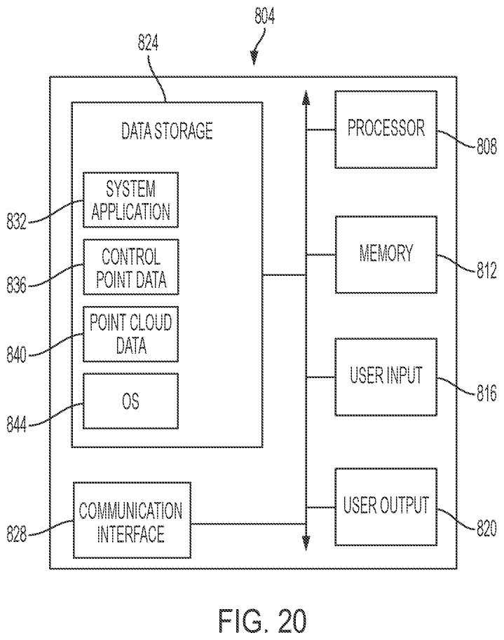

As can be appreciated by one of skill in the art after consideration of the present disclosure, the basic components of the lidar system 100 are the light source 164 and the primary receiver 744. Embodiments of the present disclosure can include all of the components illustrated in FIGS. 19A through 19D, additional or alternate components, or a subset of these components. In accordance with embodiments of the present disclosure, the range and angle measurements should all be compensated using techniques described in U.S. Pat. Nos. 8,184,276 and 8,467,044. The memory 764 can be used for storing the location information, operating instructions, generated data, and the like. An input/output or communication interface 768 can be included for transmitting determined information to a monitoring and control station 804 (see FIG. 20) or other system or control center in real-time, near real-time, or asynchronously. A power source and distribution bus 772 can also be integrated with the lidar system 100. Various elements of a lidar system 100 as disclosed herein can be provided as or by discrete or integrated components. For example, the various receivers 744, 756, and 760 can be implemented as photo-sensitive detectors formed in the same semiconductor substrate. Moreover, optical elements, such as beam splitters 740, 750, and or 751 can be formed on a substrate that is bonded, soldered, or otherwise attached to the semiconductor substrate in which the photo-sensitive detectors are formed, creating an integrated chip or package.

In embodiments that include components distributed amongst different housings, such as the lidar systems 100c (depicted in FIG. 19C) and 100d (depicted in FIG. 19D), the submersible housing 104 is generally interconnected to the control system 106 by an intermediate member 316. The intermediate member 316 can be provided as a flexible tether 26 or a rigid pole or structure, or as a combination of rigid and flexible elements. Where the intermediate member 316 is a rigid pole, it can be joined to the submersible housing 104 by a pan and tilt head 320. Although referred to herein as a pan and tilt head 320, the submersible housing 104 can be joined to the intermediate member 316 by a head unit 320 that provides only a pan or a tilt function. The pan and tilt head 320 can allow the submersible housing 104 to be pointed along a desired line of sight. In addition, the pan and tilt head 320 can be part of a system for placing the submersible housing at a desired location within or adjacent an underwater structure of interest, and for obtaining a desired viewing angle of that structure.

In accordance with embodiments in which the intermediate member 316 is implemented as a flexible tether, a pan and tilt head 320 can be omitted. The intermediate member 316 can include one or more signal lines 706 for carrying control signals from the control system 106 to the submersible housing 104. Alternatively or in addition, the intermediate member 316 can include one or more power supply lines 714 for carrying power from the control system 106 or some other source of power to the submersible housing 104. In various embodiments, including but not limited to embodiments in which a light source 164 is disposed within the control system 106 rather than in the submersible housing 104, as illustrated in FIG. 19C, the signal lines 706 can include optical fibers. In accordance with still other embodiments of the present disclosure, the signal lines 706 and/or power supply lines 714 can be replaced by wireless interconnections between the control system 106 and the submersible housing 104.

A submersible housing 104 that is provided separately from a control system 106 can include the optics, such as the scanning mechanism 124, transmit/receive optics 720, and receive telescope 730, and a primary receiver 744. In accordance with at least some embodiments of the present disclosure, the submersible housing 104 can include beam splitters 740, 750 and first temperature channel 756 and second temperature channel 760 receivers, as in other embodiments of the present disclosure. Also like other embodiments, various other components, such as but not limited to variable polarization rotators 716, 732, variable focus optics 708, variable filters 712, communications interfaces 768, light sources 164, and an enclosure window 108, can be provided as part of the submersible housing 104.

The submersible housing 104 can additionally include an attitude sensor 707 and a temperature sensor 709 (see, e.g., FIGS. 19C and 19D). As examples, but without limitation, the attitude sensor 707 can be in the form of a micro-electromechanical system (MEMS) gyroscope or accelerometer, while the temperature sensor 709 can be in the form of a thermistor, RTD temperature sensor, or other sensing device in the wall of the submersible housing 104.

In accordance with further embodiments of the present disclosure, a single control system 106 can be operably connected to multiple submersible housings 104. The multiple submersible housings 104 can be operated simultaneously, to reduce the total amount of time required to complete the acquisition of point cloud data from a volume.

In accordance with still other embodiments of the present disclosure, a lidar system 100 submersible housing 104 can be mounted to a vehicle, such as to an exterior of a submersible vessel 16 or a surface vessel 18. In such an embodiment, the submersible housing 104 can be interconnected to the vessel 16 or 18 using a pan and tile head 320. Moreover, such an embodiment can include a single, complete submersible housing 104, or can have components divided between a submersible housing 104 and a control system 106.

FIG. 20 is a block diagram depicting elements of a human or user interface and other components included in a monitoring and control station 804 that can be provided as part of or in conjunction with an underwater lidar system 100 in accordance with embodiments of the present disclosure. In accordance with any of the embodiments, the monitoring and control station 804 can be implemented on a platform or device, such as but not limited to a desktop, laptop, or handheld computer, that is provided separately from the components of the lidar system 100 itself. The user interface system 804 can establish communications with the lidar system 100 via wireless or wireline connections. As another example, the monitoring and control station 804 can be provided as part of a top side control portion or a control system 104 portion of a lidar system 100. The functions of the user interface system 804 can include providing command and control signals to the lidar system 100, receiving data from the lidar system 100, processing data received from the lidar system 100 or other sources, and generating output that is displayed to a user, stored, transmitted, or the like. Accordingly, the monitoring and control station 804 facilitates or performs functions that can include providing output to and receiving input from a user or from an automated processing center. The monitoring and control station 804 generally includes a processor 808 and memory 812. In addition, the monitoring and control station 804 can include one or more user input devices 816 and one or more user output devices 820. The monitoring and control station 804 also generally includes data storage 824. In addition, a communication interface 828 can be provided, to support interconnection of the monitoring and control station 804 to the underwater components of the lidar system 100, and/or to other systems. The communication interface 828 can also be used as an interface to another autonomous device that provides the inputs and reads outputs that replaces human user interfaces 816 and 820.

The processor 808 may include a general purpose programmable processor or any other processor capable of performing or executing instructions encoded in software or firmware. In accordance with other embodiments of the present disclosure, the processor 808 may comprise a controller, FPGA, or ASIC capable of performing instructions encoded in logic circuits. The memory 812 may be used to store programs and/or data, for example in connection with the execution of code or instructions by the processor 808. As examples, the memory 812 may comprise RAM, SDRAM, or other solid-state memory. In general, the user input device 816 is included as part of the monitoring and control station 804 and allows a user to input commands, including commands that are transmitted to the underwater components of the lidar system 100, to control that system 100. Examples of user input devices 816 that can be provided as part of the monitoring and control station 804 include a keyboard, keypad, microphone, biometric input device, touch screen, joystick, mouse, or other position encoding device, or the like. The user output device 820 can provide a representation of data collected by the lidar system, information regarding the operational status, location, and orientation of the lidar system 100, and information relevant to the status and operation of other devices, such as a platform 16 or 18 carrying the lidar system 100. A user output device 820 can, for example, include a display, speaker, indicator lamp, or the like. Moreover, a user input device 816 and a user output device 820 can be integrated, for example through a graphical user interface with a pointing device controlled cursor or a touchscreen display.

Like the memory 812, the data storage 824 may comprise a solid-state device. Alternatively or in addition, the data storage 824 may comprise, but is not limited to, a hard disk drive, a tape drive, or other addressable storage device or set of devices. Moreover, the data storage 824 can be provided as an integral component of the monitoring and control station 804, or as an interconnected data storage device or system. The data storage 824 may provide storage for an underwater monitoring system application 832 that operates to present a graphical user interface through the user output device 820, and that presents point cloud data, or data derived from point cloud data, obtained by one or more underwater monitoring systems 304. The application 832 can further operate to receive control commands from a user through the user input device 816, including commands selecting targets or other control points on an underwater structure or feature. In accordance with embodiments of the present disclosure, the application 832 can perform various functions autonomously, such as identifying underwater structures, identifying features on underwater structures, identifying weld seams in pipes or tunnels, identifying joints in pipes or tunnels, identifying holes or leaks in pipes and tunnels, identifying holes and perforations in downhole applications, identifying cracks and crack orientations in downhole applications, identifying fluid velocity in a pipe, tunnel, or underwater environment, identifying fluid type, combining fluid velocity with hole or pipe geometry to calculate flow rate of a fluid, identifying a centroid of an underwater structure or a feature of an underwater structure 204, identifying control points on underwater structures, identifying target centroids, monitoring the motion, vibration, and/or temperature parameters of underwater structures, or other operations. Such automated operations can be implemented using, for example, image recognition techniques on 2D, 3D, or multi-dimensional data. The data storage 824 can additionally provide storage for the selected control points 836, for point cloud data 840 generated by operation of one or more lidar systems 100, and for range, vibration, vibration mode, temperature, leak detection, or other measurements or data generated by a lidar system 100. In accordance with still other embodiments of the present disclosure, the system application 832 can be executed to detect motion, vibration, vibration mode, temperature, changes, features, lack of features, other anomalies, or leaks instead of or in conjunction with execution of the system software by the processor 748 of the lidar system 100. The data storage 824 can also store operating system software 844, and other applications or data.

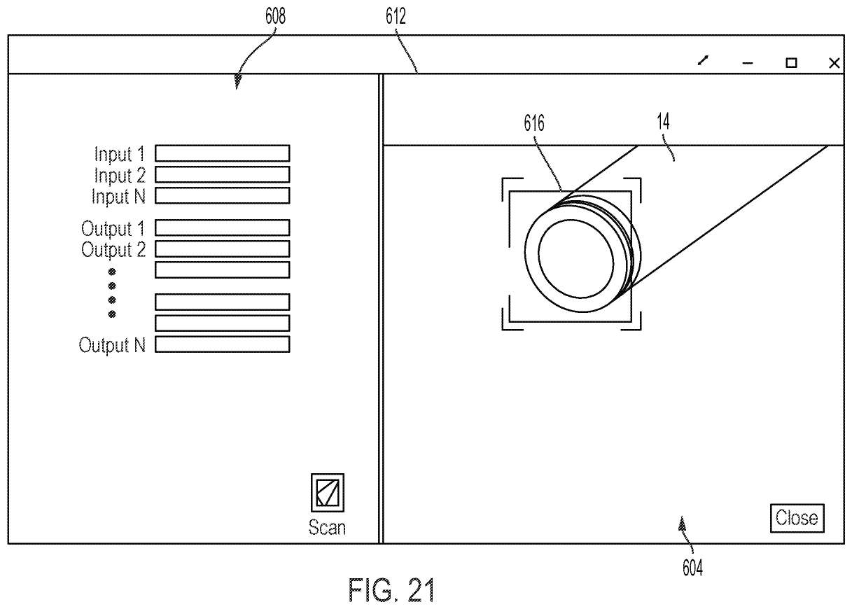

An example of a user interface 604 presented to a user by a user output device 820 is depicted in FIG. 21. As shown, the user interface 604 can include a user input section 608 containing a variety of data entry fields and virtual buttons that can be utilized by a user to enter control instructions or data through manipulation of one or more user input devices 816. The user interface 604 can additionally present an image 612 of the equipment, structure, or underwater scene generated from the point cloud data obtained by the lidar system 100. The image 612 can be associated with or overlaid by icons 616 and information relevant to the operation of the lidar system 100, including the location, pointing, and other operating parameters of the submersible housing 104, such as location, pointing direction, operating status, and the like.

Advantages of a lidar system in accordance with embodiments of the present disclosure over alternative methods include enabling non-touch measurements and reduced tooling. Using the lidar system 100 as compared to alternative metrology systems can reduce the installation time of clamped tooling and underwater logged data recovery along with the risk of touching the underwater structures. In addition, in hard to reach locations such as downhole or inside pipes, penstock, or water tunnels, vibration measurements can be made at the same time as the 3D data is acquired as opposed to requiring a second deployment to reach the location of interest.

Methods and devices for vibration monitoring are also enabled. An underwater optical, laser, or lidar device provided as part of the lidar system 100 can be used to measure vibration of the structure or feature at a standoff distance with no contact of the actual structure or feature itself. Multiple devices can be used from different orientations to capture motion in all directions as opposed to just along a single line of sight.

Methods and devices for measuring movement and displacement in X, Y, Z planes, including angular tilts are provided by a lidar system 100 in accordance with embodiments of the present disclosure. An underwater optical, laser, or lidar device provided as part of the lidar system 100 can be used to measure displacement or movement of the structure or feature at a standoff distance with no contact of the actual structure or feature itself. The method is remote and non-contact providing the benefits of no tooling requirements or retrofits to old equipment. The standoff range is limited to the device itself, which could be over 50 m for an underwater lidar system 100. The device makes a rapid number of range and angle measurements to the target. Alternately, multiple single spots can be scanned. Alternately, a laser line scan system, structured light sensor, or flash lidar could be used to make range, angle, angle measurement on multiple points simultaneously. The range and angles measurements should all be compensated using techniques described in U.S. Pat. Nos. 8,184,276 and 8,467,044. Multiple devices can be used from different orientations to capture motion in all directions as opposed to just along a single line of sight.

Methods and devices provided as part of the lidar system 100 provide for single or multiple scanners to be time synchronized or independent measurement devices at any one time.

Methods or devices provided as part of the lidar system 100 enable the range, angle, or imaging measurement to be made by a method selected from the group consisting of: laser scanning, lidar, flash lidar, laser triangulation, photometric stereo, stereoscopic vision, structured light, photoclinometry, stereo-photoclinometry, holographic systems, AMCW phase detection, chirped AMCW, amplitude FMCW, true FMCW, pulse modulation codes, time of flight pulse detection, and any combination of these, and wherein the angle or imaging measurement is made by a device comprising elements selected from the group consisting of scanning systems, a multi-detector system or camera (2D or 3D) where each detector pixel equates to an angle, and any combination of these. Moreover, a range, angle or imaging measurement can include measuring a voltage, time, frequency, phase, number of samples, number of digits, encoder, pixel count, or fringe count. Alternatively or in addition, making a range, angle or imaging measurement can include scaling or adjusting a measured voltage, time, frequency, phase, number of samples, number of digits, encoder, pixel count, or fringe count by the measured or calculated index of refraction of the medium.

In accordance with at least some embodiments of the present disclosure, a lidar system 100 can be operated using known reference points in the vessel, cavity, pool, tunnel, pipe, dam, or well site being monitored or surveyed to confirm if a structure has moved in relation to the reference point. The reference point can also be used for location tracking of an object within the vessel, cavity, pool, tunnel, pipe, dam, or well site in relative coordinates to the reference point.

Applications for and methodologies incorporating lidar systems 100 in accordance with embodiments of the present disclosure include, but are not limited to:

Non-Destructive Examination (NDE) Visual Inspections

High resolution inspections are required for pressure retaining structures and components in the nuclear reactor cavities and vessels, in piping in downhole applications, and in hydroelectric dams. Welds, bolting, pump casing interiors, valve body interiors, pipe joints, holes, interior attachments to the reactor vessel, reactor vessel interior, reactor vessel removable core support structures and reactor pressure vessel component external surfaces require inspection for cracks, degradation and deformities.

A 3-D point cloud of the object is generated from the scan. The 3D point cloud can be visualized with color mapped to intensity or color mapped to range. In one embodiment, an operator manually scans the object for defects by looking for color changes or shapes in the data. The data captured can be zoomed in at areas of interest to provide clearer more precise determinations of the observed object's condition. New scans can be performed of areas of interest at higher resolutions.

In another embodiment the 3D point cloud of the object is compared to a previous point cloud and differences auto-highlighted. In this scenario the comparison can be performed on point clouds, models generated from the point clouds, or both. This operation can be performed manually or automatically.

In another embodiment software automatically detects features of interest, such as pipe joints, leaks, holes, and cracks. The software then automatically detects and measures the key features and returns a reduced dataset of the key information of the feature of interest to the surface or user interface that is remote. This reduces the data bandwidth requirement for the communication system.

Not only is the area of intended inspection captured but all other surrounding areas as well. This allows for new areas of interest requiring evaluations in the future to be easily referenced or trended to past data already archived. This greatly reduces the need to perform future in-the-field inspections because the data was already archived during past scans of the entire viewing area. This eliminates the cost of mobilizing new equipment for inspections or many of hours of video data mining.

Downhole

Drilling applications for oil, gas, geothermal, groundwater, mining, and any other application where drilling is performed in natural ground (above or below water) or manmade (such as concrete). 360° inspection of the drill hole is desirable to learn more about the material (such as in mining when looking for fault lines, minerals, etc. or looking at different rock layers when drilling for oil and gas). Often the drill hole is filled with a liquid, so imaging through a liquid is required. Passive imaging with a camera can be used however passive lighting in liquids (especially turbid liquids) causes strong back reflections which reduce the contrast of the resulting image. Cameras also do not provide the 3D data required for measurements. Crack inspection is also of interest, especially in concrete.

Pipelines

Pipeline inspections can include above and below ground, above and below water, and even below the ocean floor. Pipes are used to carry liquids or gas products (flow operations). Pipeline owners regularly inspect internal pipelines to ensure integrity and flow assurance or flow performance specifications are achieved. The ability to inspect without draining the pipe saves both time, money, or is simply not possible based upon the pipeline being long or too light when dried internally. Suspending pipeline flow operation may also generate further integrity risks such as thermal expansion shock and vertical or lateral movements. Typical inspections include locating leaks, locating and measuring holes and cracks, and locating and measuring corrosion or build-up from materials such as wax, hydrates or other high viscous materials that restrict and prevent flow; locating, inspecting, and measuring welds, seams, joints, and other features along with fluid types through Raman spectra analysis. The ability to auto-detect features while moving a submersible housing 104 down the pipe is possible with automated algorithms and AI. Attitude, linear movement, other navigation data, and temperature probes can be combined to reproduce a full 3D dataset automatically with anomalies and feature classification in conjunction with material reflective properties, or in post processing to determine likely remediation requirements. Reduced data sets can be sent back to the surface that just report on anomalies or areas of interest, such as leak locations and size, hole location and size, or crack location, orientation, and size.

Water Tunnels and Penstock

Water tunnel and penstock inspections can include above and below ground, above and below water, and below lakebeds and seabeds. Several of the major water tunnel infrastructure that feed major US cities are approaching a century in age. The ability to perform inspections and measurements without draining the water is highly beneficial to the operators and end users. The same is true for penstock and other assets in hydroelectric dams. The tunnels are usually made of either metal or concrete and this invention can be used for locating and measuring leaks, locating and measuring holes and cracks, locating and measuring corrosion or build-up, locating, inspecting, and measuring welds, seams, joints, and other features. The ability to auto-detect features while moving down a pipe, tunnel, or wall is possible with automated algorithms and AI. Attitude, linear movement, and other navigation data can be combined to reproduce a full 3D dataset automatically or in post processing. Reduced data sets can be sent back to the surface that just report on anomalies or areas of interest, such as leak locations and size or crack location, orientation, and size.

Seafloor

Wide area scanning of the seafloor is important for both assessment of environmental conditions, unexploded ordinance, and man-made structures and assets such as pipelines and telecommunications cables. For instance, prior to fixed monopile or floating wind turbine farm installations, and the associated inner power cable and export cable paths and routes, environmental assessment must be made of the seafloor to understand the environmental impact. Oftentimes it is regulated to inspect and monitor the impact during the life of the wind farm until decommissioning is complete. Additional marine life habitat monitoring and species growth and species density may be obtained from safe altitudes as to not disturb marine life. This includes monitoring the viability for fishing activities. This also applies to deep-water mining such as the assessment of polymetallic nodules. Typical tools for this type of inspection include SONAR or cameras. Cameras require the vehicle to be close to the seabed (1-4 meters), which means a wide area cannot be covered in a single track and the potential to disturb marine life. Sonars have wide area field of view (>100°) searches and can be used at long range, however the resolution is low. A wide-angle lidar can enable detailed surveys of sea life from 10s of meters altitude above the seabed with sub-cm resolution thus enabling detailed surveys of wide areas in a shorter amount of time. The same is true for pipelines, cables, well sites, dam walls, deepwater polymetallic mining, habitat monitoring, and other large-area inspections required.

Embodiments of the present disclosure provide a lidar system 100 that can include an attitude sensor or an inertial navigation sensor that is integrated into the submersible housing 104 to compensate for motion of the submersible housing 104 while travelling down a pipe or tunnel. This information is combined with distance traveled information in order to reconstruct 3D data of the pipe or tunnel. A camera can be integrated into the system through the same window or a different window in order to apply SLAM tracking on the 2D images to assist in producing navigation information. The full 3D rendering can be produced through automatic software on the sensor or in post processing once the data is downloaded after the deployment and recovery.

In accordance with further embodiments of the present disclosure, a lidar system 100 can include multiple submersible housings 104 scanning different areas at the same time to reduce total data collection time, especially while scanning large tunnels or underwater objects. This can include multiple submersible housings 104 mounted on the same vehicle or multiple submersible housings 104 mounted on different vehicles to increase the speed of data collection. Embodiments of the present disclosure are also capable of taking range-resolved Raman spectra-based water temperature or fluid/target identification measurements and use that information to help reconstruct the 3D data. In addition, a lidar system 100 as disclosed herein can take water velocity measurements at a leak or hole and combine that information with 3D area information of the leak or hole to calculate a flow rate of the liquid.

Forward Looking Field of View

At least some embodiments of the present disclosure enable a forward-looking field of view, in addition to one or more side-looking fields of view. There are instances where a combination of forward-looking and side-looking fields of view are desirable. It is possible to achieve this with the pressure tolerant window 108 attached to the endcap 112. The side-looking field of view is accomplished as has been described. For the forward field of view the end of the window 108 should be flat and polished within the optical field of view. The advantage of using a reflector 146 that includes a mirror 152 disposed within a cube 150 as opposed to a standard mirror is it can be viewed directly through the cube 150. A simple camera could be used for forward looking inspections, however a passive light source is required for this, which can include an integrated LED ring in the endcap 112. The reflective coating inside the optic 150 can be narrow band so it reflects the one wavelength but allows all other wavelengths to pass, thus allowing optical imaging through the cube.

In accordance with at least some embodiments, a laser imaging system is used to provide 3D data, without requiring a passive light source. Passive light systems in combinations with cameras have difficulty resolving objects in the presence of turbid water due to the backscatter of the passive light vastly reducing the contrast in the image. As previously discussed, dichroic or polarization selective coatings can be used to reflect some light for the side looking scans and transmit some light for the forward looking scans.

In at least some embodiments, the cube 150 of the scanning mechanism 124 has a polarization selective surface that reflects s-polarization and transmits p-polarization. The laser selected can be linearly polarized, or can be polarized using external polarization optics. The polarization of the laser can be switched from s-polarization to p-polarization using a half-wave plate, liquid crystal device, EO device, or other polarization sensitive optic to enable the cube mirror to select between side looking and forward looking scanning/imaging.

In another embodiment the reflective surface 152 in the cube 150 is liquid crystal or another switching device. The liquid crystal is turned on or off to allow transmission or reflection of the main beam.

Scanning can occur by multiple methods. One method is to use a Risley Prism pair to maintain the axial symmetry of the scanning mechanism 124. The prisms are held in two additional hollow-core motors. This allows for two-dimensional scanning in the forward direction. The scanner for the radial direction may or may not be held still during this time. As opposed to a Risley Prism scanner, a steering mirror (such as galvanometer or spinning polygon mirrors), or other beam steering device, such as a micro-electro-mechanical system (MEMs), liquid crystal, liquid crystal meta-surfaces, acousto-optic, Optical Phased Array (OPA), Serpentine OPA, electro-optic device, fluid-based beam steering, one or two axis fast steering mirror, or any combination thereof may be used.

A common problem with downhole operations is a tool can become disconnected and “lost” during operations. Often times the exact interface to re-attach to the tool is unknown and the orientation of the tool is unknown. The resulting operation is called “fishing” where a coupling tool is attached to the end of the drill string and blind attempts are made to attach to the tool for recovery. This blind operation can take hours, days, and sometimes weeks to successfully remove the tool. Downhole cameras are sometimes used, however the backscatter from the passive lighting required for cameras can greatly reduce contrast and visibility. An improvement is to use a forward-looking 3D sensor as described here. The 3D sensor can scan the tool location and orientation downhole. In another embodiment, all the tools can be scanned on the topside to create a 3D model that can be used to best fit on the downhole image in case the data acquired is imperfect. Point clouds can be fit to point clouds, model to point clouds, or model to model. Using this method the type of tool and tool orientation can be determined with high confidence. A library of tool models/point clouds can be generated on-site or off-site. These are then used as templates that are compared to the point cloud acquired downhole and then applied to identify the tool in the hole, along with orientation. This concept can be used for any features of interest in any application, not just downhole applications.

In another embodiment, the tools can have barcodes, ID tags, etched markings, or other markings that are identifiable by the 3D data to uniquely identify the tool. Unique tool identification can be captured in a database to track information about the tool such as use time, use under what conditions, and use locations for example.

Integrated Flow Meter

As opposed to just 3D scanning of the system, a Doppler velocimeter can be integrated into the lidar system 100 to provide measurements of fluid velocity. By measuring fluid velocity along with the actual measured dimensions of a hole, true flow rate can be calculated and reported for a leak, hole, or flow within a pipe. This can be combined with other measurements such as temperature, pressure, and fluid type through Raman spectra detection.

Integrated Spectrometer

With the pressure tolerant window 108 and a beam steering mechanism 124, other optical sensors can be integrated within the lidar system 100. For instance, an optical spectrometer can be integrated to measure the contents of the fluid the sensor is immersed in. This is particularly useful in downhole environments. As opposed to a full spectrometer, an optical sensor that detects only specific fluids or gases can be integrated into the lidar system 100. For instance, a Differential Absorption Lidar (DIAL) could be integrated into the system to measure specific compounds such as methane or ethane.

Side-Looking Field of View Mounted In-Line with Tool

A side-looking field of view can be achieved with stacked prisms that use dichromatic to reflect two different wavelengths for the different sides of the 360° scan. For compactness, one can use laser diodes of two different wavelengths for laser source 164 and have different receivers 166 with different narrow band filters to detect the different wavelengths. Alternately, one can use polarization selection as opposed to dichromatic optics.

In accordance with at least some embodiments of the present disclosure, the technology encompasses:

(1) A lidar system, comprising:
a housing;
a window disposed in the housing, wherein the window allows light of at least a selected wavelength to pass between an interior of the housing and an exterior of the housing;
a scanning mechanism, including:
   a hollow-core motor; and
   a reflector, wherein the motor is operational to spin the reflector about a first axis;
a light source, wherein the light source produces light, wherein the light source is configured to direct the light along or adjacent to the first axis to the reflector, and wherein the light is reflected by the reflector through the window.

(2) The system of (1), wherein the housing includes an endcap, and wherein the window is disposed in the endcap.

(3) The system of (1) or (2), wherein the window is cylindrical in form and protrudes from the endcap, and wherein the window includes a lateral transmissive portion.

(4) The system of any of (1) to (3), wherein the window defines an interior volume in which the reflector is received.

(5) The system of any of (1) to (4), wherein the window enables a full 360° field of view about the first axis.

(6) The system of any of (1) to (5), further comprising:
a protective shroud, wherein the protection shroud extends around at least some exterior portions of the window.

(7) The system of (6), wherein the shroud enables a field of view about the first axis that is less than 360°.

(8) The system of (5), wherein the reflector directs a first component of the light from the light source within the 360° field of view about the first axis, and wherein the reflector passes a second component of the light from the light source along a line that is parallel to the first axis through an end surface of the window.

(9) The system of any of (1) to (8), wherein the light produced by the light source and directed along or adjacent to the first axis passes through a center portion of the hollow-core motor.

(10) The system of (1), wherein the window is disposed in a sidewall of the housing.

(11) The system of any of (1) to (10), wherein the reflector includes:
a cube of glass or transparent material; and
a reflector surface disposed within the cube of glass or transparent material.

(12) The system of any of (1) to (10), wherein the reflector includes first and second cubes of glass or transparent material, wherein the first cube includes a first reflector to direct light along a first line of sight relative to the first axis, and wherein the second cube includes a second reflector to direct light along a second line of sight relative to the first axis.

(13) The system of (12), wherein, relative to the first axis, the first line of sight is radially offset from the second line of sight.

(14) The system of (12) or (13), wherein the first reflector reflects light of at least a first wavelength, and wherein the second reflector reflects light of at least a second wavelength.

(15) The system of any of (12) to (14), wherein the reflector reflects light of a first initial polarization, and wherein the second reflector reflects light of a second initial polarization.

(16) The system of any of (1) to (10), wherein the reflector includes:
a first reflector surface, wherein the reflector surface transmits light of a first polarization and reflects light of a second polarization, wherein the first reflector surface is disposed along and at an angle to the first axis, and wherein a first side of the first reflector surface facing the light source defines a first field of view;
a second reflector surface, wherein the second reflector surface is disposed on a side of the first reflector surface opposite the light source and perpendicular to the first axis; and
a quarter wave plate, wherein the quarter wave plate is between the first reflector surface and the second reflector surface, wherein light of the second polarization is passed by the first reflector surface, passed a first time through the quarter wave plate, reflected by the second reflector surface, passed a second time through the quarter wave plate, thereby converting the light reflected by the second reflector surface to the second polarization, and reflected by a second side of the first reflector surface facing the second reflector, wherein the second side of the reflector defines a second field of view.

(17) The system of any of (1) to (16), wherein the cube of glass or transparent material is disposed symmetrically about the first axis.

(18) The system of any of (1) to (18), wherein the housing is a submersible housing, wherein the light source and the reflector are disposed within the submersible housing, and wherein the submersible housing is operatively connected to a control system by an intermediate member.

In accordance with further aspects of the present disclosure, the technology encompasses:

(19) A method for scanning an underwater scene, comprising:
providing a submersible housing, the submersible housing including:
   a window; and
   a scanning mechanism, including a hollow core motor and a reflector;
operating the motor to rotate the reflector about a first axis; and
passing a beam of light through the hollow core motor and to the reflector, wherein the reflector is operable to scan an area within a first field of view.

In accordance with still further aspects of the present disclosure, the technology encompasses:

(20) A system, comprising:
a vehicle;
a lidar system, the lidar system including:
   a submersible housing, the submersible housing including:
      a light source, wherein the light source produces a beam of light that is directed along a first axis;
      a window;
      a hollow core motor;
      a reflector, wherein the reflector is joined to the hollow core motor and is rotated about the first axis, wherein the reflector directs light received from the light source across a first field of view.

The foregoing discussion has been presented for purposes of illustration and description. Further, the description is not intended to limit the disclosed systems and methods to the forms disclosed herein. Consequently, variations and modifications commensurate with the above teachings, within the skill or knowledge of the relevant art, are within the scope of the present disclosure. The embodiments described hereinabove are further intended to explain the best mode presently known of practicing the disclosed systems and methods, and to enable others skilled in the art to utilize the disclosed systems and methods in such or in other embodiments and with various modifications required by the particular application or use. It is intended that the appended claims be construed to include alternative embodiments to the extent permitted by the prior art.

What is claimed is:

1. A lidar system, comprising:
a housing;
a window disposed in the housing, wherein the window allows light of at least a selected wavelength to pass between an interior of the housing and an exterior of the housing;
a scanning mechanism, including:
a hollow-core motor; and
a reflector, wherein the motor is operational to spin the reflector about a first axis;
a light source, wherein the light source produces light, wherein the light source is configured to direct the light along or adjacent to the first axis to the reflector, and wherein the light is reflected by the reflector through the window.

2. The system of claim 1, wherein the housing includes an endcap, and wherein the window is disposed in the endcap.

3. The system of claim 2, wherein the window is cylindrical in form and protrudes from the endcap, and wherein the window includes a lateral transmissive portion.

4. The system of claim 3, wherein the window defines an interior volume in which the reflector is received.

5. The system of claim 4, wherein the window enables a full 360° field of view about the first axis.

6. The system of claim 2, further comprising:
a protective shroud, wherein the protection shroud extends around at least some exterior portions of the window.

7. The system of claim 6, wherein the shroud enables a field of view about the first axis that is less than 360°.

8. The system of claim 5, wherein the reflector directs a first component of the light from the light source within the 360° field of view about the first axis, and wherein the reflector passes a second component of the light from the light source along a line that is parallel to the first axis through an end surface of the window.

9. The system of claim 1, wherein the light produced by the light source and directed along or adjacent to the first axis passes through a center portion of the hollow-core motor.

10. The system of claim 1, wherein the window is disposed in a sidewall of the housing.

11. The system of claim 1, wherein the reflector includes:
a cube of glass or transparent material; and
a reflector surface disposed within the cube of glass or transparent material.

12. The system of claim 1, wherein the reflector includes first and second cubes of glass or transparent material, wherein the first cube includes a first reflector to direct light along a first line of sight relative to the first axis, and wherein the second cube includes a second reflector to direct light along a second line of sight relative to the first axis.

13. The system of claim 12, wherein, relative to the first axis, the first line of sight is radially offset from the second line of sight.

14. The system of claim 12, wherein the first reflector reflects light of at least a first wavelength, and wherein the second reflector reflects light of at least a second wavelength.

15. The system of claim 12, wherein the reflector reflects light of a first initial polarization, and wherein the second reflector reflects light of a second initial polarization.

16. The system of claim 1, wherein the reflector includes:
a first reflector surface, wherein the reflector surface transmits light of a first polarization and reflects light of a second polarization, wherein the first reflector surface is disposed along and at an angle to the first axis, and wherein a first side of the first reflector surface facing the light source defines a first field of view;
a second reflector surface, wherein the second reflector surface is disposed on a side of the first reflector surface opposite the light source and perpendicular to the first axis; and
a quarter wave plate, wherein the quarter wave plate is between the first reflector surface and the second reflector surface, wherein light of the second polarization is passed by the first reflector surface, passed a first time through the quarter wave plate, reflected by the second reflector surface, passed a second time through the quarter wave plate, thereby converting the light reflected by the second reflector surface to the second polarization, and reflected by a second side of the first reflector surface facing the second reflector, wherein the second side of the reflector defines a second field of view.

17. The system of claim 1, wherein the cube of glass or transparent material is disposed symmetrically about the first axis.

18. The system of claim 1, wherein the housing is a submersible housing, wherein the light source and the reflector are disposed within the submersible housing, and wherein the submersible housing is operatively connected to a control system by an intermediate member.

19. A method for scanning an underwater scene, comprising:
providing a submersible housing, the submersible housing including:
a window; and
a scanning mechanism, including a hollow core motor and a reflector;
operating the motor to rotate the reflector about a first axis; and
passing a beam of light through the hollow core motor and to the reflector, wherein the reflector is operable to scan an area within a first field of view.

20. A system, comprising:
a vehicle;
a lidar system, the lidar system including:
a submersible housing, the submersible housing including:
a light source, wherein the light source produces a beam of light that is directed along a first axis;
a window;
a hollow core motor;
a reflector, wherein the reflector is joined to the hollow core motor and is rotated about the first axis, wherein the reflector directs light received from the light source across a first field of view.
